(19) United States
(12) Patent Application Publication
(10) Pub. No.: US 2025/0267231 A1
(43) Pub. Date: Aug. 21, 2025

(54) INFORMATION PROCESSING SYSTEM, INFORMATION PROCESSING METHOD, AND COMPUTER-READABLE STORAGE MEDIUM

(71) Applicant: CANON KABUSHIKI KAISHA, Tokyo (JP)

(72) Inventor: REI ISHIKAWA, Saitama (JP)

(21) Appl. No.: 19/056,929

(22) Filed: Feb. 19, 2025

(30) Foreign Application Priority Data
Feb. 20, 2024 (JP) 2024-023538

(51) Int. Cl. H04N 1/32; H04N 1/00

(52) U.S. Cl. CPC H04N 1/32117; H04N 1/00212; H04N 1/00233; H04N 1/00413; H04N 1/00461

(57) ABSTRACT

An information processing system includes: a reception unit configured to receive setting of a transmission rule set by a user via a setting screen to manage setting to transmit an image; a selection unit configured to select an image to be paired with the transmission rule from an image associated with the user; an association unit configured to associate the image selected by the selection unit with the transmission rule; and a display control unit configured to make display the image selected by the selection unit and the transmission rule on the setting screen as relevant information associated by the association unit.

### BACKGROUND OF THE INVENTION

### Field of the Invention

The present disclosure relates to a technique of setting a transmission rule of an image.

### Description of the Related Art

Recent years, along with the development of the Internet, cloud services have been used by many people as a service that can be used via the Internet. As one of the above-mentioned cloud services, a storage service that stores an image transmitted from a camera has been known. Regarding this storage service, Japanese Patent Laid-Open No. 2013-045352 discloses a technique of selecting an image as a transmission target from multiple images held in a camera in accordance with a condition (a transmission rule) designated by a user for each object category characterizing an object appearing in the image.

For example, a scene in which a transmission rule for the transmission of an image of a photograph capturing a race of bicycle motocross (BMX) is assumed. Here, a case where “sports” and “vehicle” are prepared as an object category is assumed. The BMX corresponds to “sports,” while the bicycle, as “vehicle”, appears in the photograph simultaneously. Therefore, in some cases, it is difficult for the user to determine which object category the image has been assigned to, transmitted, and saved.

### SUMMARY OF THE INVENTION

An information processing apparatus according to an aspect of the present disclosure includes: a reception unit configured to receive setting of a transmission rule set by a user via a setting screen to manage setting to transmit an image; a selection unit configured to select an image to be paired with the transmission rule from an image associated with the user; an association unit configured to associate the image selected by the selection unit with the transmission rule; and a display control unit configured to make display the image selected by the selection unit and the transmission rule on the setting screen as relevant information associated by the association unit.

Further features of the present invention will become apparent from the following description of exemplary embodiments with reference to the attached drawings.

### BRIEF DESCRIPTION OF THE DRAWINGS

FIG. 1A is a diagram illustrating an example of a network configuration of the information processing system, FIG. 1B is a diagram illustrating an example of a network constituent included in the network configuration in FIG. 1A, FIG. 1C is a diagram illustrating an example of a constituent of an information processing apparatus in FIG. 1B, and FIG. 1D is a diagram illustrating an example of a configuration of a computer system used for the information processing apparatus in FIG. 1C;

FIG. 2A is a diagram illustrating an example of a software configuration of the information processing apparatus, FIG. 2B is a flowchart illustrating an example of processing of displaying a setting screen of a transmission rule that is executed by the information processing apparatus, and FIG. 2C is a flowchart illustrating an example of processing of setting the transmission rule that is executed by the information processing apparatus;

FIG. 3A is a flowchart illustrating an example of processing of transmitting an image that is executed by the information processing apparatus, and FIG. 3B is a flowchart illustrating an example of processing of transmitting an action that is executed by the information processing apparatus;

FIG. 4 is a flowchart illustrating an example of an operation of the information processing apparatus;

FIG. 5 is a flowchart illustrating an example of an operation of the information processing apparatus;

FIG. 6A is a diagram illustrating a result of an analysis processing in S402, FIG. 6B is a diagram illustrating data used for processing in S408, FIG. 6C is a diagram illustrating data used for processing in S314, FIG. 6D illustrates a result of recognition processing in S301, and FIG. 6E is a diagram illustrating data used for processing in S223;

FIG. 7A illustrates an example of a management screen of the transmission rule, FIG. 7B is a diagram illustrating an example of the setting screen of the transmission rule, and FIG. 7C is a diagram illustrating an example of the setting screen of the transmission rule;

FIG. 8A is a diagram illustrating an example of the management screen of the transmission rule, FIG. 8B is a diagram illustrating an example of an image list screen displaying a list of images stored in a storage unit, and FIG. 8C is a diagram illustrating an action selection screen from which an action on the image is selected;

FIG. 9 is a flowchart illustrating an example of an operation of the information processing apparatus;

FIG. 10A is a diagram illustrating a result of analysis processing in S902, FIG. 10B is a diagram illustrating data used for processing in S908, and FIG. 10C is a diagram illustrating a result of the analysis processing in S902;

FIG. 11A is a diagram illustrating an example of the setting screen of the transmission rule, and FIG. 11B is a diagram illustrating an example of the setting screen of the transmission rule;

FIG. 12A is a flowchart illustrating an example of processing of selecting one of multiple images, and FIG. 12B is a flowchart illustrating a flow of processing of completing the setting of the transmission rule by the information processing apparatus;

FIG. 13 is a flowchart illustrating an example of an operation of the information processing apparatus;

FIG. 14A is a diagram illustrating an image group to which the image belongs and a blur evaluation value of an image analyzed by a recognition unit in S1303 in a case where the setting screen of the transmission rule is generated, and FIG. 14B is a diagram illustrating the setting screen of the transmission rule in the present modification; and

FIG. 15A is a diagram illustrating an example of the setting screen of the transmission rule in a modification of the present embodiment, FIG. 15B is a diagram illustrating a screen example in a case where a CPU functioning as a reception unit receives information indicating that a help button is tapped on the setting screen of the transmission rule in FIG. 15A, and FIG. 15C is a diagram illustrating an example of a candidate of a representative image.

### DESCRIPTION OF THE EMBODIMENTS

Preferred embodiments of the present disclosure are described below in detail with reference to the appended drawings. Note that, the following embodiments are not intended to limit the matters of the present disclosure, and not all the combinations of the characteristics described in the following embodiments are necessarily required for the means for solving the problems of the present disclosure. Note that, the same reference numerals are provided to the same constituents. The present embodiment is described by using an image formation apparatus as an example of an information processing apparatus; however, it is not limited thereto.

### First Embodiment

### Overview

There is a cloud service that allows for automatic transferring or supplying of an image that is consistent with a transmission rule to various services. In a case of using the above-mentioned cloud service, an expected image is automatically transferred to the various services by appropriately setting the transmission rule. However, in some cases, it is difficult for a user to determine which transmission rule is appropriate for selecting the expected image from many images and for automatically transferring or sharing the image. Therefore, in the present embodiment, an operation is performed in which an image, to be paired with the transmission rule, is selected from an image associated with the user, the selected image and the transmission rule are associated with each other, and then the associated image and transmission rule are displayed on a setting screen. With the above-mentioned operation, the user can confirm the image paired with the transmission rule. The image paired with the transmission rule is the image selected from the image associated with the user; for this reason, the image displayed on the setting screen is an image related to the user and the transmission rule. Accordingly, the image displayed on the setting screen can provide the user with a hint for the setting of the transmission rule. Thus, it is possible to assist the setting of the transmission rule. That is, the user can intuitively understand the transmission rule by visually confirming the image displayed on the setting screen. Thus, in a case where the user sets the transmission rule, it is possible to easily figure out which image conforms to which object category. Note that, the various services include a social networking service (SNS), a cloud storage service of an image, and a cloud storage service of various files, for example. The various services may include a cloud service that provides a creative environment for editing a moving image and the like on the Internet.

### Overall Configuration

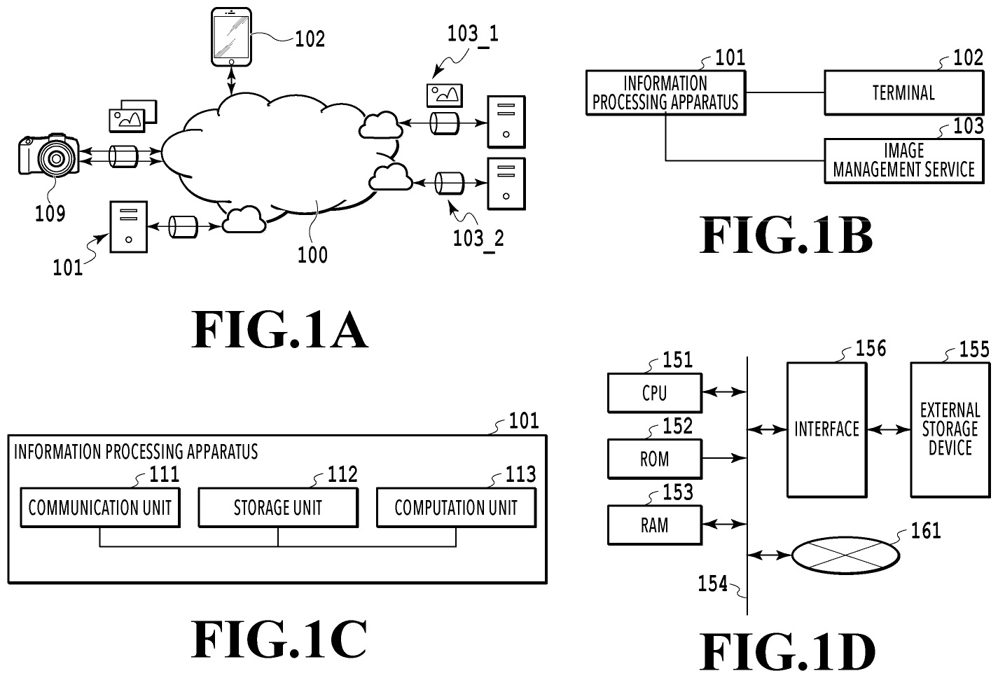

FIG. 1A is a diagram illustrating an example of a network configuration of the information processing system. FIG. 1B is a diagram illustrating an example of a network constituent included in the network configuration in FIG. 1A. FIG. 1C is a diagram illustrating an example of a constituent of an information processing apparatus 101 in FIG. 1B. The information processing system includes at least two network constituents. The network constituents are connectable to each other via the Internet 100. The network constituents include the information processing apparatus 101, a terminal 102, image management services 103_1 and 103_2, and an image capturing apparatus 109, for example. Note that, in the following descriptions, the image management services 103_1 and 103_2 are collectively called as an image management service 103.

The information processing system in FIG. 1A provides a cloud service that can be used via the Internet 100. This cloud service automatically transfers or shares the image that is consistent with a condition included in the setting of the transmission rule to the various services. In FIG. 1A, an example in which the cloud storage service of the image is implemented by the image management service 103 as one of the various services is illustrated. Additionally, in FIG. 1A, an example in which the image automatically transferred to the various services is captured by the image capturing apparatus 109 is illustrated. Moreover, although it is assumed that the transmission rule is set by the terminal 102 in FIG. 1A, equipment that can set the transmission rule is not limited to the terminal 102.

### (Image Capturing Apparatus 109)

The image capturing apparatus 109 captures an image. The image capturing apparatus 109 can transmit the captured image to the cloud storage service of the image based on the transmission rule via the Internet 100. As long as the image capturing apparatus 109 is an apparatus that has a function of capturing an image and a function of transmitting the image via the Internet 100, any apparatus may be applicable. For example, the image capturing apparatus 109 is formed of a digital camera. Alternatively, the image capturing apparatus 109 may be formed of a smartphone with an image capturing element. Note that, a main body of the image capturing apparatus 109 may not have the function of transmitting the image via the Internet 100. For example, the function of transmitting the image via the Internet 100 may be implemented by implementing a communication function to a semiconductor memory that stores data of the captured image and is attachable to and detachable from the main body of the image capturing apparatus 10.

### (Terminal 102)

The terminal 102 has an input and output function and a communication function. The input and output function in the terminal 102 is formed of a liquid crystal display with a touch panel, for example. The communication function in the terminal 102 includes a wireless communication function, for example. The wireless communication function can be implemented by at least one of Wi-Fi (registered trademark), Bluetooth (registered trademark), and near field communication (registered trademark; NFC), for example. The terminal 102 is formed of a smartphone, for example. Alternatively, the terminal 102 may be formed of a tablet. The terminal 102 transmits and receives various types of information via the Internet 100. In a case where the setting of the transmission rule is inputted by the input and output function in the terminal 102, the cloud service implemented by the network constituents of the information processing system can perform the following operation. That is, the above-described cloud service can transmit the image captured by the image capturing apparatus 109 to the image management service 103 based on the setting of the transmission rule. Note that, in a case where the terminal 102 is formed of the smartphone, it is possible to connect the above-described cloud service to the Internet 100 via a mobile phone line by using a base station and a switching center.

### (Image Management Service 103)

The image management service 103 is formed of an apparatus different from the information processing apparatus 101. Alternatively, the image management service 103 may be implemented as a web service, for example. The web service implemented by the image management service 103 may function as a part of a service provided by the cloud service. Thus, the image management service 103 may function as one of the network constituents implementing the cloud service.

In the present embodiment, a case where the image is a still image is mainly described below; however, it is not particularly limited thereto. The image may be a moving image. That is, the information processing system can process the image regardless of whether the image is a still image or a moving image. In the following descriptions, unless otherwise stated, it is described that a phrase, which is the image, may include both the concepts of a moving image and a still image.

### (Information Processing Apparatus 101)

The information processing apparatus 101 includes a communication unit 111, a storage unit 112, and a computation unit 113. The communication unit 111 is a unit that implements the communication function of the information processing apparatus 101. The communication unit 111 is formed of a network card or the like, for example. The communication unit 111 is a unit that transmits and receives various types of information via the Internet 100. For example, the communication unit 111 transmits and receives the various types of information to and from the terminal 102. The various types of information in the communication with the terminal 102 are information inputted in the terminal 102. Alternatively, the various types of information in the communication with the terminal 102 may be information to be displayed on a display screen of the terminal 102. Additionally, for example, the communication unit 111 transmits and receives the various types of information to and from the image management service 103. The various types of information in the communication with the image management service 103 are image information of an image as a transmission target, for example. The image information may include exchangeable image file format (Exif) information. The Exif information is image capturing date and time, image capturing place (in a case where a GPS function is ON), a model name of the image capturing apparatus, an aperture value, an ISO sensitivity, an exposure correction value, and the like, for example. Note that, the information processing apparatus 101 may be formed of an image formation apparatus. In a case where the information processing apparatus 101 is formed of the image formation apparatus, it is possible to perform various types of printing according to a printing instruction. Additionally, the information processing apparatus 101 may include a mail server. In a case where the information processing apparatus 101 includes the mail server, it is possible to transmit and receive an e-mail. The above-described image formation apparatus and mail server may be provided outside the information processing system.

The storage unit 112 is a unit that stores various data such as the image and various programs. The storage unit 112 is implemented by a random access memory (RAM), a read only memory (ROM), a hard disk drive (HDD), and the like, for example. As the storage unit 112, a solid state drive (SSD) may be used instead of the HDD.

The computation unit 113 is a unit that executes various programs of processing of transmitting and receiving or storing the various data, for example. The computation unit 113 is implemented by a central processing unit (CPU), a graphics processing unit (GPU), or the like, for example. The cloud service in the present embodiment may be implemented with the computation unit 113 executing the program stored in the storage unit 112. Alternatively, the cloud service in the present embodiment may be implemented by the terminal 102. Alternatively, the cloud service in the present embodiment may be implemented by the image management service 103. Alternatively, the cloud service in the present embodiment may be implemented via the Internet 100 by virtualizing at least one of the information processing apparatus 101, the terminal 102, and the image management service 103. Thus, the information processing apparatus 101 may function as one of the network constituents implementing the cloud service.

### [Hardware Configuration]

FIG. 1D is a diagram illustrating an example of a configuration of a computer system used for the information processing apparatus 101 in FIG. 1C. A bus 154 in FIG. 1D is connected to a CPU 151, a ROM 152, a RAM 153, an interface 156, and a network 161. In addition to the Internet 100 in FIG. 1A, the network 161 includes at least one of a wide area network (WAN), a local area network (LAN), and an intranet, for example. The ROM 152 and the RAM 153 are connected to the CPU 151 via the bus 154. The ROM 152 stores a program executed by the CPU 151 and fixed data of a parameter for computation. The RAM 153 provides a working region for the CPU 151 and a temporary storage region of data. Additionally, an external storage device 155 is connected to the bus 154 via the interface 156. Therefore, the external storage device 155 is connected to the CPU 151 via the interface 156 and the bus 154. The external storage device 155 is formed of a hard disk device, for example. Alternatively, the external storage device 155 may be formed of a magneto-optical disk (MO). Alternatively, the external storage device 155 may be formed of a CD-ROM. With the above-described connection configuration using the bus 154, the CPU 151 can execute an operating system (OS) and various application programs and perform various controls.

### [Software Configuration]

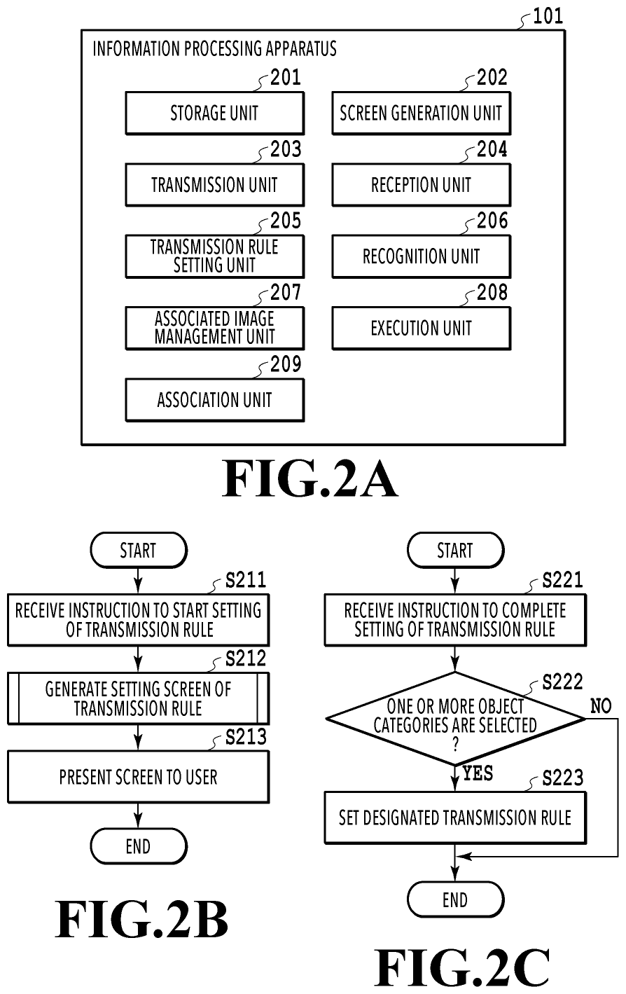

FIG. 2A illustrates an example of a software configuration of the information processing apparatus 101. The CPU 151 in FIG. 1D implements the various types of software of the information processing apparatus 101 as functional blocks by executing the program according to the present embodiment. The various types of software include a storage unit 201, a screen generation unit 202, a transmission unit 203, a reception unit 204, a transmission rule setting unit 205, and a recognition unit 206, for example. Additionally, the various types of software may include an associated image management unit 207, an execution unit 208, and an association unit 209. Note that, the various types of software included in FIG. 2A may be implemented as one of the cloud services implemented via the Internet 100. Therefore, the various types of software according to the present embodiment may be implemented by cloud computing that can access on demand via the Internet 100 to a resource including not only the information processing apparatus 101 but also another network constituent. In other words, it is possible to implement the various programs according to the present embodiment as a configuration of cloud computing that shares one function with multiple resources and performs processing in cooperation via the Internet 100. Hereinafter, for the sake of simple descriptions, an aspect in which the CPU 151 executes various types of processing in the present embodiment is described; however, the various types of processing may be executed with a configuration of cloud computing.

The storage unit 201 has a function of storing the image in the storage unit 112. Note that, the storage unit 201 may store the image in the cloud storage service. The screen generation unit 202 has a function of generating a screen to set the transmission rule of the image and transmitting the screen to the terminal 102 via the communication unit 111 in FIG. 1C. The transmission unit 203 has a function of transmitting the image stored in the storage unit 201 to the image management service 103 via the communication unit 111 in FIG. 1C. The reception unit 204 has a function of receiving an instruction by the user operated on the screen displayed on the terminal 102 via the terminal 102 via the communication unit 111 in FIG. 1C. The transmission rule setting unit 205 has a function of storing in the storage unit 112 the transmission rule for the determination on whether to transmit the image based on the instruction by the user received by the reception unit 204. The recognition unit 206 has a function of executing recognition processing of the image on the image stored in the storage unit 112 and storing a result of the execution in the storage unit 112. In the present embodiment, the recognition unit 206 has a function of recognizing a category of an object appearing in the image. In the present embodiment, there are four types of the object categories, which are “food”, “animal”, “vehicle”, and “scenery”, for example. The recognition unit 206 has a function of recognizing an arbitrary number of the object categories for each image. Specifically, there are a case where zero or no object category is recognized, a case where a single object category is recognized, and a case where multiple object categories are recognized. Here, a case where the number of the object categories is zero indicates that the object in the image corresponds to none of “food”, “animal”, “vehicle”, and “scenery”. The associated image management unit 207 has a function of storing the image associated by the association unit 209 in the storage unit 112. The execution unit 208 has a function of executing an action on the image stored in the storage unit 112 based on the instruction by the user received by the reception unit 204. In the present embodiment, the action is at least one of an operation to print the image by using the image formation apparatus and an operation to transmit the image with a mail via the mail server. Here, the image formation apparatus may be arranged outside the information processing system and usable via the Internet 100. Additionally, the mail server may be implemented outside the information processing system and usable via the Internet 100. The association unit 209 has a function of associating the image stored in the storage unit 112 with the condition included in the setting of the transmission rule. The screen generation unit 202 has a function of displaying the image associated with each condition in a case where the above-described condition is displayed on the setting screen of the transmission rule. In the present embodiment, the object category is used as the condition included in the setting of the transmission rule. That is, in a case where the object category as the condition is consistent with the object category appearing in the image, it is assumed that the condition included in the setting of the transmission rule is met. Details of the object category are described later. Note that, in addition to the object category, yet another element may be added as the condition included in the setting of the transmission rule. The other element includes a blur in the image or an exposure in the image, for example; details thereof are described later.

### [Processing of Presenting Setting Screen of Transmission Rule]

In the descriptions hereinafter, first, each processing is described individually, and thereafter an example in which multiple types of processing are in cooperation with each other to execute the present embodiment is described. Specifically, processing of setting the transmission rule via the setting screen of the transmission rule is described with reference to FIGS. 2B and 2C. FIG. 2B is a flowchart illustrating an example of processing of displaying the setting screen of the transmission rule that is executed by the information processing apparatus 101. The processing illustrated in FIG. 2B is implemented with the computation unit 113 of the information processing apparatus 101 executing the program stored in the storage unit 112. The processing illustrated in FIG. 2B is executed in a timing in which the screen generation unit 202 generates a management screen of the transmission rule. That is, the processing illustrated in FIG. 2B is implemented by the CPU 151. Note that, a part of or all the functions of steps in FIG. 2B may be implemented by hardware such as an ASIC or an electronic circuit. A sign “S” in description of each processing means that it is a step in the corresponding flowchart. Additionally, it is possible to implement the processing illustrated in FIG. 2B also as a configuration of cloud computing that shares one function with multiple resources and performs processing in cooperation via the Internet 100. Note that, the meaning of the above-described timing may be something causing the processing. Therefore, the meaning of the above-described description may be that “the execution of the processing is caused by the generation of the management screen of the transmission rule by the screen generation unit 202”. Hereinafter, in the present embodiment, the word, which is the timing, is used as a similar meaning.

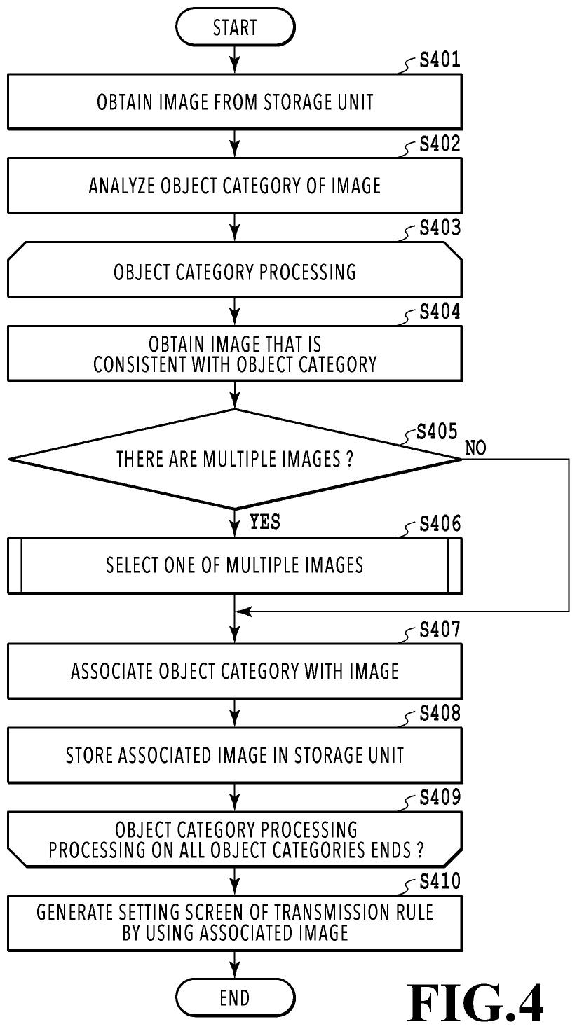

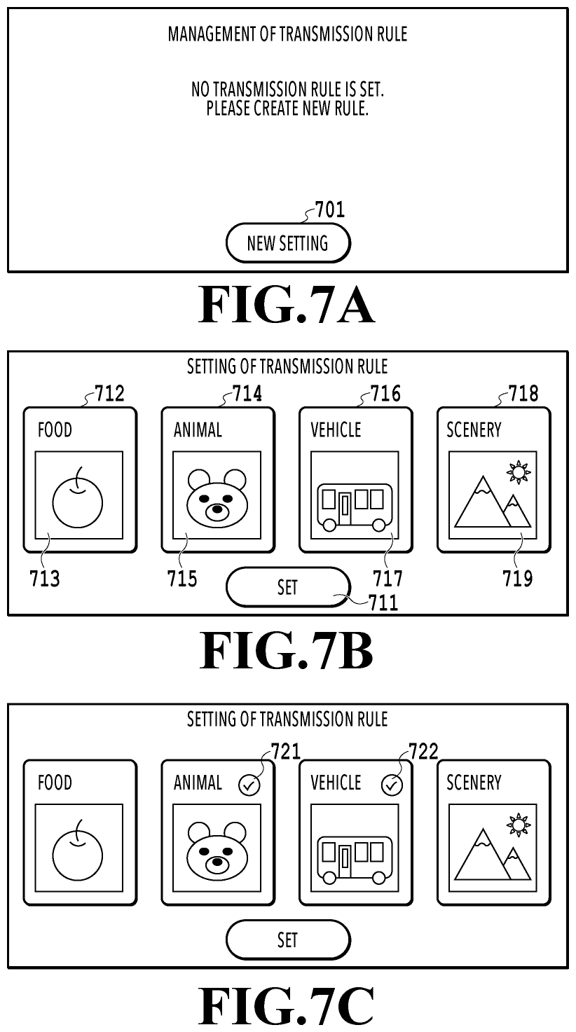

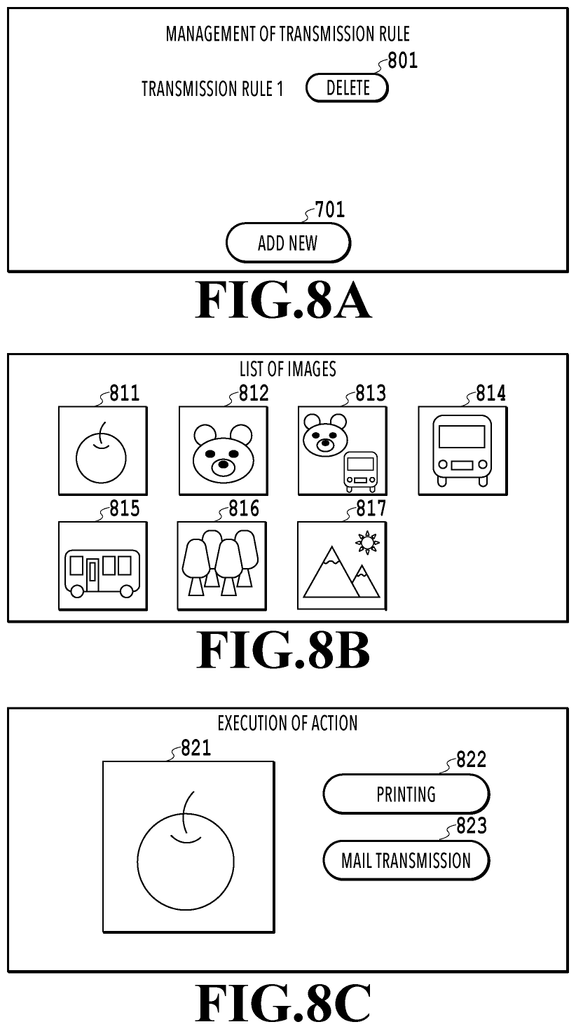

In S211, the CPU 151 functioning as the reception unit 204 receives an instruction to start the setting of the transmission rule via the management screen of the transmission rule. Here, the transmission rule is a rule to transmit the image as the transmission target to the cloud storage service of the image or the storage in a case where a specific condition is met. The specific condition is whether the object belonging to the object category appears in the image, for example. Here, the object category is an index that characterizes the object appearing in the image. For example, the object includes “apple”, “bear”, “bus”, and “sun and mountain”. It is possible to extract the index characterizing each of those objects by abstracting the object. For example, “apple” that is abstracted to a fruit can be further abstracted to “food”. Additionally, “bear” is abstracted to “animal”. Moreover, “bus” is abstracted to “vehicle”. Furthermore, “sun and mountain” is abstracted to “scenery”. That is, in a case where the objects are “apple”, “bear”, “bus”, and “sun and mountain”, the indexes characterizing the objects appearing in the image correspond to “food”, “animal”, “vehicle”, and “scenery”, respectively. The image as the transmission target is a transmission candidate image captured by the image capturing apparatus 109, for example. The index characterizing a candidate object appearing in the transmission candidate image is a candidate category. Therefore, in a case where the object category is consistent with the candidate category, it is possible to set the setting of the transmission processing to transmit the transmission candidate image as the transmission rule. That is, in a case where the specific condition that the object category is consistent with the candidate category is met, the transmission processing is executed. Additionally, the cloud storage service of the image is a service implemented by the image management service 103. Moreover, the management screen is a screen to manage the transmission rule and is a screen that functions as an interface to receive the operation by the user related to the management of the transmission rule. The management screen is displayed on the terminal 102, for example. Details of the management screen are described later with reference to FIGS. 7A and 8A. In S212, the CPU 151 functioning as the screen generation unit 202 generates the setting screen of the transmission rule. Here, the setting screen is a screen to receive the setting to transmit the image and is a screen that functions as an interface to receive the operation by the user related to the setting of the transmission rule. Details of the setting screen are described later with reference to FIGS. 7B and 7C. Details of the processing in S212 are described later with reference to FIG. 4. In S213, the CPU 151 functioning as the screen generation unit 202 transmits the setting screen generated by the processing in S212 to the terminal 102 via the communication unit 111. With this operation, the terminal 102 displays the setting screen of the transmission rule. Specifically, the screen generation unit 202 generates the information of the setting screen of the transmission rule, and the generated information of the setting screen of the transmission rule is transmitted to the terminal 102 via the communication unit 111. The terminal 102 renders the information of the setting screen of the transmission rule that is transmitted from the communication unit 111 and displays the information on a not-illustrated screen. Once performing the processing in S213, the CPU 151 ends the present flowchart including the processing from S211 to S213. According to the above-mentioned operation, since the terminal 102 displays the setting screen of the transmission rule, it is possible to set the transmission rule from the terminal 102. Note that, a transmission destination of the setting screen of the transmission rule is not limited to the terminal 102. As long as it is equipment that can use the cloud storage service of the image according to the present embodiment, it is possible to apply the equipment as the transmission destination of the setting screen of the transmission rule.

### [Processing of Setting Transmission Rule]

FIG. 2C is a flowchart illustrating an example of processing of setting the transmission rule that is executed by the information processing apparatus 101. The processing illustrated in FIG. 2C is implemented with the computation unit 113 of the information processing apparatus 101 executing the program stored in the storage unit 112. The processing illustrated in FIG. 2C is executed in a timing in which the screen generation unit 202 generates the setting screen of the transmission rule. That is, the processing illustrated in FIG. 2C is implemented by the CPU 151. Note that, a part of or all the functions of steps in FIG. 2C may be implemented by hardware such as an ASIC or an electronic circuit. A sign “S” in description of each processing means that it is a step in the corresponding flowchart. Additionally, it is possible to implement the processing illustrated in FIG. 2C also as a configuration of cloud computing that shares one function with multiple resources and performs processing in cooperation via the Internet 100.

In S221, the CPU 151 functioning as the reception unit 204 receives an instruction to complete the setting of the transmission rule. The instruction to complete the setting of the transmission rule is implemented by the operation on the setting screen of the transmission rule. Details of the instruction to complete the setting of the transmission rule are described later with reference to FIG. 7B. In S222, the CPU 151 functioning as the transmission rule setting unit 205 determines whether one or more object categories are selected. If one or more object categories are selected, the CPU 151 allows the processing in S222 to proceed to the processing in S223. If zero object category is selected, the CPU 151 ends the present flowchart including the processing from S221 to S223. That is, if at least one object category is selected, the CPU 151 allows the processing in S222 to proceed to the processing in S223. In S223, the CPU 151 functioning as the transmission rule setting unit 205 stores the transmission rule designated by the user in the storage unit 112 as the processing of setting the designated transmission rule. Once performing the processing in S223, the CPU 151 ends the present flowchart including the processing from S221 to S223.

### [Processing of Transmitting Image]

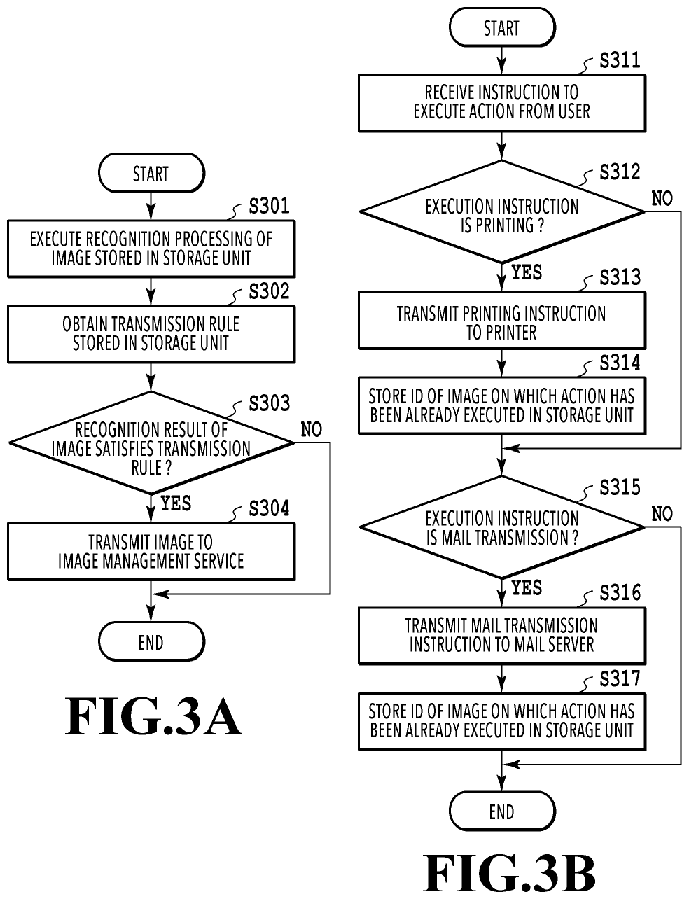

Next, processing of transmitting the image as the transmission target by using the transmission rule set by the processing in FIGS. 2B and 2C is described with reference to FIG. 3A. FIG. 3A is a flowchart illustrating an example of the processing of transmitting the image that is executed by the information processing apparatus 101. The processing illustrated in FIG. 3A is implemented with the computation unit 113 of the information processing apparatus 101 executing the program stored in the storage unit 112. The processing illustrated in FIG. 3A is executed in a timing in which the storage unit 201 stores a new image in the storage unit 112. That is, the processing illustrated in FIG. 3A is implemented by the CPU 151. Note that, a part of or all the functions of steps in FIG. 3A may be implemented by hardware such as an ASIC or an electronic circuit. A sign “S” in description of each processing means that it is a step in the corresponding flowchart. Additionally, it is possible to implement the processing illustrated in FIG. 3A also as a configuration of cloud computing that shares one function with multiple resources and performs processing in cooperation via the Internet 100. Note that, the processing illustrated in FIG. 3A is not limited to the execution in the timing in which the new image is stored. That is, the processing is not necessarily executed every time the new image is stored. For example, after multiple new images are stored, the processing illustrated in FIG. 3A may be executed all at once. In such an operation, the number of times the information processing apparatus 101 accesses the image management service 103 is reduced, and thus it is possible to reduce the power consumption of the information processing apparatus 101. Additionally, in a case where the number of times the information processing apparatus 101 accesses the image management service 103 is reduced, it is also possible to leave a resource of the image management service 103 that is secured for the processing from the information processing apparatus 101 for another not-illustrated network constituent. Accordingly, it is possible to improve the convenience of all the service users.

In S301, the CPU 151 functioning as the recognition unit 206 performs the recognition processing of the image stored in the storage unit 112. Here, the image on which the recognition processing is performed may not be the image stored in the storage unit 112. The image on which the recognition processing is performed may be an image that can be taken from the storage service. Additionally, the recognition processing is processing of extracting the object category to which the object appearing in the image belongs. For example, the recognition processing may be executed by pattern recognition. The pattern recognition is processing of extracting a specific regulation or characteristic from the image. An algorithm of the pattern recognition includes a neural network, a support vector machine, and the like, for example. With any of the algorithms above, it is possible to extract the object appearing in the image and to obtain the object category to which the extracted object belongs. In addition, the algorithm of the pattern recognition may be deep learning in which the number of intermediate layers of the neural network is increased. With the deep learning, it is possible to extract the characteristic of the object more accurately than the neural network, and thus it is possible to set a further detailed object category. Moreover, against the deep learning, the algorithm of the pattern recognition may be a large language model that performs learning with a great amount of data sets. With the large language model, it is possible to extract the characteristic of the object more precisely than the deep learning, and it is possible to set the object category further strictly. In any case, as long as the algorithm that extracts the characteristic and the like included in the image can identify which object category the object appearing in the image belongs to, any algorithm may be applicable. In S302, the CPU 151 functioning as the transmission unit 203 obtains the transmission rule stored in the storage unit 112. In S303, the CPU 151 functioning as the transmission unit 203 determines whether a result of the recognition processing of the image that is obtained in S301 satisfies the transmission rule obtained in S302. To satisfy the transmission rule means that the condition included in the setting of the transmission rule is met. For example, in a case where the object category is consistent with the candidate category that characterizes the candidate object appearing in the transmission candidate image, the CPU 151 determines that the transmission rule is satisfied. If the transmission rule is satisfied, the CPU 151 allows the processing in S303 to proceed to the processing in S304. If the transmission rule is not satisfied, the CPU 151 ends the present flowchart including the processing from S301 to S304. In S304, the CPU 151 functioning as the transmission unit 203 transmits the image to the image management service 103 and ends the present flowchart including the processing from S301 to S304. That is, if the transmission rule is satisfied, the CPU 151 transmits the transmission candidate image to the image management service.

### [Processing of Executing Action]

A result of the processing illustrated in FIG. 3B is processing referred to during the execution of S212 included in the processing illustrated in FIG. 2B. During the processing in S212, processing in S406 included in processing illustrated in FIG. 4 is executed, and during the processing in S406, processing of extracting the image used for the action is executed; details thereof are described later. That is, in a case of executing the processing of extracting the image used for the action, an image on which the action has been already executed, which is executed by the processing illustrated in FIG. 3B, is referred to out of the multiple images. FIG. 3B is a flowchart illustrating an example of processing of transmitting the action that is executed by the information processing apparatus 101. The processing illustrated in FIG. 3B is implemented with the computation unit 113 of the information processing apparatus 101 executing the program stored in the storage unit 112. The processing illustrated in FIG. 3B is executed in a timing in which the reception unit 204 receives an instruction to execute the action. That is, the processing illustrated in FIG. 3B is implemented by the CPU 151. Note that, a part of or all the functions of steps in FIG. 3B may be implemented by hardware such as an ASIC or an electronic circuit. A sign “S” in description of each processing means that it is a step in the corresponding flowchart. Additionally, it is possible to implement the processing illustrated in FIG. 3B also as a configuration of cloud computing that shares one function with multiple resources and performs processing in cooperation via the Internet 100.

In S311, the CPU 151 functioning as the reception unit 204 receives the instruction to execute the action from the user. Details of the instruction to execute the action are described later with reference to FIG. 8C. In S312, the CPU 151 functioning as the execution unit 208 determines whether the instruction to execute the action received in S311 is the printing instruction. If the instruction to execute the action is the printing instruction, the CPU 151 allows the processing in S312 to proceed to the processing in S313. If the instruction to execute the action is not the printing instruction, the CPU 151 allows the processing in S312 to proceed to the processing in S315. In S313, the CPU 151 functioning as the execution unit 208 transmits the printing instruction to an external image formation apparatus via the communication unit 111. In S314, the CPU 151 functioning as the execution unit 208 stores an image ID as an identifier that can uniquely designate the image on which the action has been already executed in the storage unit 112 as an action-executed-already image. That is, the image ID may be stored in the storage unit 112 while the image on which the action, or printing, has been already executed and the image ID corresponding to the image on which the action has been already executed are associated with each other. In S315, the CPU 151 functioning as the execution unit 208 determines whether the instruction to execute the action received in S311 is a mail transmission instruction. If the instruction to execute the action is the mail transmission instruction, the CPU 151 allows the processing in S315 to proceed to the processing in S316. If the instruction to execute the action is not the mail transmission instruction, the CPU 151 ends the present flowchart including the processing from S311 to S317. In S316, the CPU 151 functioning as the execution unit 208 transmits the mail transmission instruction to the external mail server via the communication unit 111. In S317, the CPU 151 functioning as the execution unit 208 stores the ID of the image on which the action has been already executed as the action-executed-already image in the storage unit 112. That is, the image ID may be stored in the storage unit 112 while the image on which the action, or mail transmission, has been already executed and the image ID corresponding to the image on which the action has been already executed are associated with each other. The present flowchart including the processing from S311 to S317 ends.

### [Detailed Generation Method of Setting Screen of Transmission Rule]

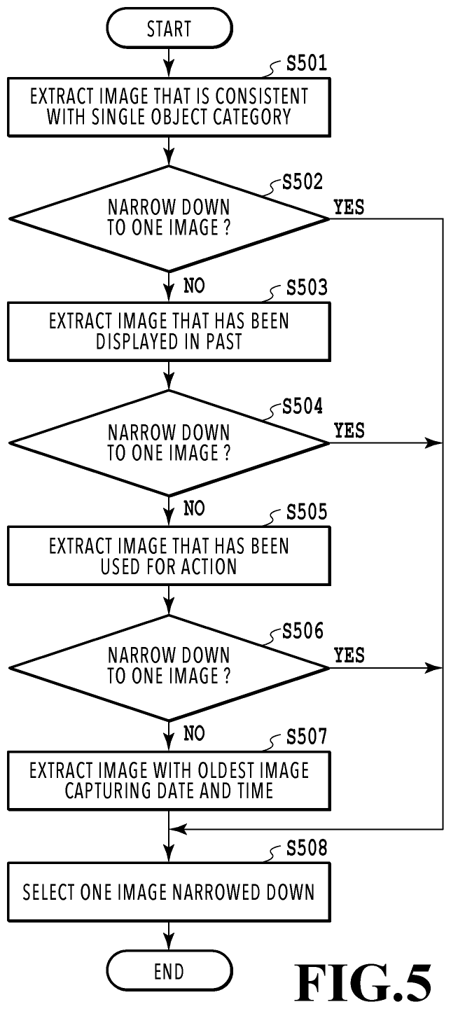

FIG. 4 is a flowchart illustrating an example of an operation of the information processing apparatus 101. FIG. 4 illustrates details of the processing in S212. Specifically, the processing from S401 to S410 in FIG. 4 is processing of generating the setting screen of the transmission rule. The processing illustrated in FIG. 4 is implemented with the computation unit 113 of the information processing apparatus 101 executing the program stored in the storage unit 112. The processing illustrated in FIG. 4 is executed in a timing in which the processing in S212 in FIG. 2B is called. That is, the processing illustrated in FIG. 4 is implemented by the CPU 151. Note that, a part of or all the functions of steps in FIG. 4 may be implemented by hardware such as an ASIC or an electronic circuit. A sign “S” in description of each processing means that it is a step in the corresponding flowchart. Additionally, it is possible to implement the processing illustrated in FIG. 4 also as a configuration of cloud computing that shares one function with multiple resources and performs processing in cooperation via the Internet 100. Note that, in the present embodiment, the object category is used as the condition included in the setting of the transmission rule. Therefore, the processing illustrated in FIG. 4 is processing of selecting the image to be displayed on the setting screen of the transmission rule as a representative image that represents the object category. In a case where there are multiple options for the representative image, one image is selected from the multiple images by the processing illustrated in FIG. 5 described later.

In S401, the CPU 151 functioning as the association unit 209 obtains the image from the storage unit 112. In this case, the obtained image may not be the image stored in the storage unit 112. The obtained image may be an image that can be taken from the storage service. In S402, the CPU 151 functioning as the recognition unit 206 analyzes the object category of the image obtained in S401. Here, the analysis of the object category of the image is an operation to identify which object category the object appearing in the image obtained in S401 belongs to. In S403, the CPU 151 functioning as the association unit 209 executes the processing illustrated in S404 to S408 by the number of the object categories. For example, a case where there are four object categories is assumed. Under this assumption, the CPU 151 executes the processing from S404 to S408 for each of a first object category, a second object category, a third object category, and a fourth object category. In this case, the processing from S404 to S408 is executed for each object category. That is, since the processing from S404 to S408 is executed for each designated object category, in a case where there are four object categories, the processing from S404 to S408 is executed four times in total. In S404, based on the object category of the image that is obtained in S402, the CPU 151 functioning as the association unit 209 obtains an image that is consistent with the object category designated in S403 from the image obtained in S401. In S405, the CPU 151 functioning as the association unit 209 determines whether multiple images are obtained in S404. If there are multiple images, the CPU 151 allows the processing in S405 to proceed to the processing in S406. If there is a single image, the CPU 151 allows the processing in S405 to proceed to the processing in S407. Here, a case where there are multiple images means that there are multiple images that are consistent with a specific object category. For example, it is a case where there are multiple images of the object category that is consistent with “food”. In S406, the CPU 151 functioning as the association unit 209 selects one image from the multiple images. Details of the processing in S406 are described later with reference to FIG. 5. In S407, in a case where a single image is obtained in S404, the CPU 151 functioning as the association unit 209 associates the image with the object category designated in S403. In a case where multiple images are obtained in S404, the CPU 151 associates the image selected in S406 with the object category designated in S403. In S408, the CPU 151 functioning as the associated image management unit 207 stores the image ID of the image associated in S407 as an already-associated image in the storage unit 112. In S409, in a case where the processing on all the object categories is completed, the CPU 151 allows the processing in S409 to proceed to the processing in S410. On the other hand, in a case where the processing on all the object categories is not completed, the CPU 151 returns the processing in S409 to the processing in S403. In S410, the CPU 151 functioning as the screen generation unit 202 generates the setting screen of the transmission rule by using the associated image and ends the present flowchart including the processing from S401 to S410. The CPU 151 functioning as the screen generation unit 202 uses the image associated with each object category by the CPU 151 functioning as the association unit 209 in S407 to generate the setting screen of the transmission rule.

### [Method of Selecting Display Image]

FIG. 5 is a flowchart illustrating an example of an operation of the information processing apparatus 101. FIG. 5 illustrates details of the processing in S406. Specifically, the processing from S501 to S508 in FIG. 5 is processing of selecting one image from the multiple images. The processing illustrated in FIG. 5 is implemented with the computation unit 113 of the information processing apparatus 101 executing the program stored in the storage unit 112. The processing illustrated in FIG. 5 is executed in a timing in which the processing in S406 in FIG. 4 is called. That is, the processing illustrated in FIG. 5 is implemented by the CPU 151. Note that, a part of or all the functions of steps in FIG. 5 may be implemented by hardware such as an ASIC or an electronic circuit. A sign “S” in description of each processing means that it is a step in the corresponding flowchart. Additionally, it is possible to implement the processing illustrated in FIG. 5 also as a configuration of cloud computing that shares one function with multiple resources and performs processing in cooperation via the Internet 100.

In S501, the CPU 151 functioning as the association unit 209 extracts an image that is consistent with a single object category from the multiple images. Here, to extract the image that is consistent with the single object category means that an image in which there is only one object appearing in one image is extracted since the object category is the index characterizing the object. Therefore, since the image including one object is extracted, there is also a possibility that multiple images each including one object are extracted. Note that, the CPU 151 extracts all the images in a case where there is no corresponding image. In this case, a case where there is no corresponding image means that there are multiple objects appearing in one image. In such a case, since it is impossible to narrow the images down to one image based on the object category, the CPU 151 narrows the images down based on another perspective in processing in S503 and thereafter. In S502, the CPU 151 functioning as the association unit 209 determines whether the images are narrowed down to one image as a result of the processing in S501. If the images are narrowed down to one image, the CPU 151 allows the processing in S502 to proceed to the processing in S508. If the images are not narrowed down to one image, the CPU 151 allows the processing in S502 to proceed to the processing in S503. In S503, the CPU 151 functioning as the association unit 209 extracts the image ID of the image stored as an already-displayed image out of the images extracted in S501. If there is no corresponding image, the CPU 151 extracts all the images out of the images extracted in S501. In S504, the CPU 151 functioning as the association unit 209 determines whether the images are narrowed down to one image as a result of the processing in S503. If the images are narrowed down to one image, the CPU 151 allows the processing in S504 to proceed to the processing in S508. If the images are not narrowed down to one image, the CPU 151 allows the processing in S504 to proceed to the processing in S505. In S505, the CPU 151 functioning as the association unit 209 extracts the image with the ID stored in the storage unit 112 as the action-executed-already image out of the images extracted in S503. If there is no corresponding image, the CPU 151 extracts all the images out of the images extracted in S503. In S506, the CPU 151 functioning as the association unit 209 determines whether the images are narrowed down to one image as a result of the processing in S505. If the images are narrowed down to one image, the CPU 151 allows the processing in S506 to proceed to the processing in S508. If the images are not narrowed down to one image, the CPU 151 allows the processing in S506 to proceed to the processing in S507. In S507, in a case where there are multiple images extracted in S505, the CPU 151 functioning as the association unit 209 narrows the images down to an image to which the oldest image capturing date and time information is applied. Note that, in a case where there are multiple images to which the same image capturing date and time information is applied, the CPU 151 may narrow the images down to an arbitrary one of them. Alternatively, in a case where there is no image capturing date and time information applied to the image, the CPU 151 may narrow the images extracted in S505 down to an arbitrary one image. In S508, the CPU 151 functioning as the association unit 209 selects one narrowed down image as the image to be displayed on the setting screen of the transmission rule and ends the present flowchart including S501 to S508.

### [Example of Data]

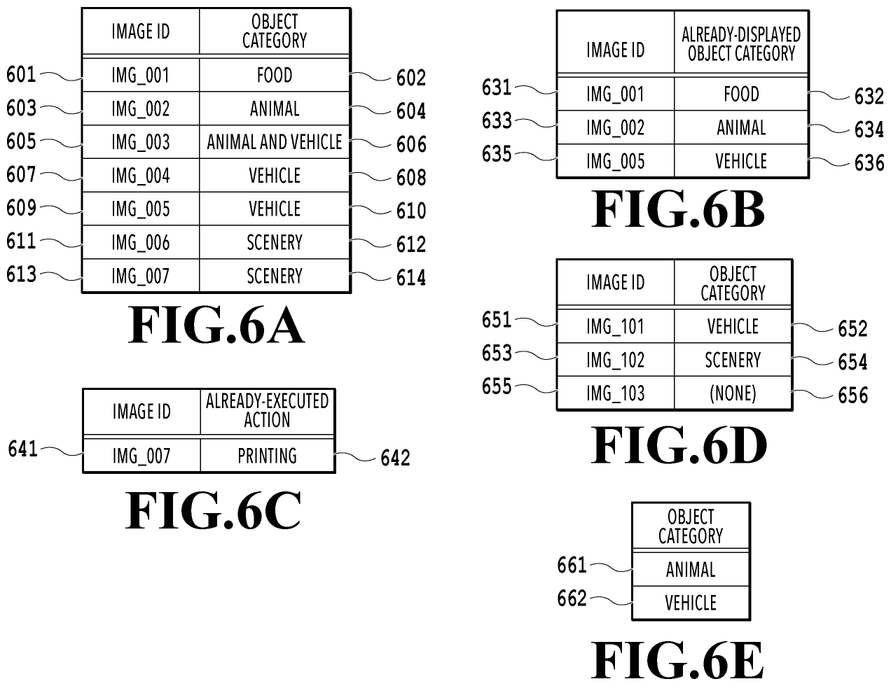

FIG. 6A illustrates a result of the analysis processing in S402. That is, FIG. 6A illustrates the object category of each image that is obtained by analyzing each image by the recognition unit 206. In a column of the image ID, information of the image ID is indicated as an identifier that allows for unique identification of each image. In a column of the object category, the object category to which the object appearing in each image belongs is indicated. That is, FIG. 6A illustrates a data set in which the image and the object category are already associated with each other. Note that, a specific object category ID as an identifier that allows for unique identification of each object category may be arrayed in the column of the object category; however, in FIG. 6A, an intuitively understandable word such as “food” is arrayed for the sake of convenient descriptions. The data set in which the image and the object category are already associated with each other is as follows, specifically. In a column 601 of the image ID, information that is “IMG_001” is arrayed. In a column 602 of the object category adjacent to the column 601 of the image ID, information indicating “food” is arrayed as the object category of the object appearing in the image identified by “IMG_001”. In a column 603 of the image ID, information that is “IMG_002” is arrayed. In a column 604 of the object category adjacent to the column 603 of the image ID, information indicating “animal” is arrayed as the object category of the object appearing in the image identified by “IMG_002”. In a column 606 of the object category adjacent to a column 605 of the image ID, information indicating “animal” and “vehicle” is arrayed as the object categories of the objects appearing in the image identified by “IMG_003”. In a column 608 of the object category adjacent to a column 607 of the image ID, information indicating “vehicle” is arrayed as the object category of the object appearing in the image identified by “IMG_004”. In a column 610 of the object category adjacent to a column 609 of the image ID, the information indicating “vehicle” is arrayed as the object category of the object appearing in the image identified by “IMG_005”. In a column 612 of the object category adjacent to a column 611 of the image ID, information indicating “scenery” is arrayed as the object category of the object appearing in the image identified by “IMG_006”. In a column 614 of the object category adjacent to a column 613 of the image ID, the information indicating “scenery” is arrayed as the object category of the object appearing in the image identified by “IMG_007”. Therefore, out of IMG_001 to IMG_007, two different object categories are confirmed in only the object categories of the objects appearing in the image identified by IMG_003. This means that the two different objects appearing in the image identified by IMG_003 can be analyzed.

FIG. 6B illustrates data used in the processing in S408. That is, FIG. 6B illustrates information of a pair of the image ID and the object category that is expected to be stored in the storage unit 112 by the associated image management unit 207. Therefore, FIG. 6B illustrates information of a pair of the image ID and the object category that is obtained by the processing from S403 to S407. Note that, in FIG. 6B, as described above with reference to FIG. 5, a case where the image that has been displayed in the past is used as the rule to select the image in the processing in S406 is assumed. Therefore, a column adjacent to a column of the image ID is “already-displayed object category”. That is, FIG. 6B illustrates a data set already used to display the object category out of the already associated data sets obtained by the processing in S402. For example, in a column 631 of the image ID, the information that is “IMG_001” is arrayed. In a column 632 of the object category adjacent to the column 631 of the image ID, the information indicating “food” is arrayed as the object category of the object appearing in the image identified by “IMG_001”. In a column 633 of the image ID, the information that is “IMG_002” is arrayed. In a column 634 of the object category adjacent to the column 633 of the image ID, the information indicating “animal” is arrayed as the object category of the object appearing in the image identified by “IMG_002”. In a column 635 of the image ID, the information that is “IMG_005” is arrayed. In a column 636 of the object category adjacent to the column 635 of the image ID, the information indicating “vehicle” is arrayed as the object category of the object appearing in the image identified by “IMG_005”. Note that, instead of the data set in FIG. 6B, the column of the object category already used for displaying may be added next to the column of the object category in FIG. 6A. Even with the data configuration mentioned above, it is possible to extract data similar to that in FIG. 6B.

FIG. 6C illustrates data used for the processing in S314. That is, FIG. 6C illustrates information of a pair of the image ID and the already-executed action that is expected to be stored in the storage unit 112 by the execution unit 208. Therefore, FIG. 6C illustrates information of a pair of the image ID and the already-executed action that is obtained by the processing from S311 to S313. For example, in a column 641 of the image ID, the information that is “IMG_007” is arrayed. In a column 642 of the already-executed action adjacent to the column 641 of the image ID, information that is “printing” is arrayed as information indicating that the image identified by “IMG_007 is used for the execution of a “printing” action. Note that, as long as the image ID is associated with information indicating that it is the already-executed action, any data configuration may be applicable. Therefore, a data configuration in which the column of the already-executed action can be referred to from the column of the image ID in FIG. 6A may be applicable. Alternatively, the column of the already-executed action may be arrayed next to the column of the image ID in FIG. 6A. On the other hand, in a case of the data used for the processing in S317, information that is “mail transmission” may be arrayed in the column of the already-executed action. Note that, as described above with reference to FIG. 5, the column of the already-executed action may be referred to in a case of extracting the image used for the action as the rule to select the image in the processing in S406.

FIG. 6D illustrates a result of the recognition processing in S301. That is, FIG. 6D illustrates the object category for each image that is obtained by analyzing each image by the recognition unit 206. The images are images newly stored in the storage unit 112 by the storage unit 201. For example, the images are images received from the terminal 102, the image management service 103, or other equipment via the communication unit 111 by the CPU 151 functioning as the storage unit 201. A result of the recognition processing is as follows, specifically. In a column 651 of the image ID, the information that is “IMG_101” is arrayed. In a column 652 of the object category adjacent to the column 651 of the image ID, the information indicating “vehicle” is arrayed as the object category appearing in the image identified by “IMG_101”. In a column 653 of the image ID, the information that is “IMG_102” is arrayed. In a column 654 of the object category adjacent to the column 653 of the image ID, the information indicating “scenery” is arrayed as the object category appearing in the image identified by “IMG_102”. In a column 655 of the image ID, information that is “IMG_103” is arrayed. In a column 656 of the object category adjacent to the column 655 of the image ID, nothing is arrayed as the object category appearing in the image identified by “IMG_103”, and it is a blank column. This means that, since no object is recognized in the image with the image ID of “IMG_103”, the object category to which the object belongs is not recognized as well, accordingly.

FIG. 6E illustrates data used for the processing in S223. That is, FIG. 6E illustrates the transmission rule generated by the transmission rule setting unit 205 and expected to be stored in the storage unit 112. In a column 661 of the object category, the information indicating “animal” is arrayed as the object category. In a column 662 of the object category, the information indicating “vehicle” is arrayed as the object category. The transmission rule illustrated in FIG. 6E indicates that the image is transmitted to the image management service 103 in a case where the object category of the image matches “vehicle” indicated in the column 661 or “animal” indicated in the column 662.

### [Screen Example]

FIG. 7A illustrates an example of the management screen of the transmission rule. As illustrated in FIG. 7A, a button 701 is arranged in the center of a lower portion of the management screen of the transmission rule. The button 701 has a function of instructing new setting of the transmission rule. Therefore, with the user operating the button 701, the management screen of the transmission rule transitions to the setting screen of the transmission rule described later with reference to FIG. 7B. With the above-mentioned operation, the user can perform new setting of the transmission rule. In the center of an upper portion of the management screen of the transmission rule, a title of the screen that is “management of transmission rule” is arranged. A message that is “No transmission rule is set. Please create a new rule” is displayed between the button 701 and the title on the screen. This message allows the user to figure out that no “transmission rule” is set to this information processing system. Additionally, with the operation of the button 701, it is possible to transition to the setting screen of the transmission rule. Next, the screen after the user operates the button 701 is described with reference to FIG. 7B.

FIG. 7B illustrates an example of the setting screen of the transmission rule. As illustrated in FIG. 7B, the setting screen of the transmission rule displays a button 711, a button 712, a button 714, a button 716, and a button 718. The button 711 is arranged in the center of a lower portion of the setting screen of the transmission rule. The button 711 has a function of instructing to complete the setting of the transmission rule. Therefore, with the user operating the button 711, it is possible to complete the setting of the transmission rule. The button 712 is arranged in the center of a left portion of the setting screen of the transmission rule. The button 712 has a function of instructing to include a case where the object category is “food” as the condition of the transmission rule. Therefore, with the user operating the button 712, it is possible to include a case where the object category is “food” as the condition of the transmission rule. In the button 712, a representative image 713 is displayed. The representative image 713 is an image representing the object category corresponding to the button 712. In the example in FIG. 7B, the image with the image ID of “IMG_001” is used as the representative image 713. The button 714 is arranged on the right of the button 712. The button 714 has a function of instructing to include a case where the object category is “animal” as the condition of the transmission rule. Therefore, with the user operating the button 714, it is possible to include a case where the object category is “animal” as the condition of the transmission rule. In the button 714, a representative image 715 is displayed. The representative image 715 is an image representing the object category corresponding to the button 714. In the example in FIG. 7B, the image with the image ID of “IMG_002” is used as the representative image 715. The button 716 is arranged on the right of the button 714. The button 716 has a function of instructing to include a case where the object category is “vehicle” as the condition of the transmission rule. Therefore, with the user operating the button 716, it is possible to include a case where the object category is “vehicle” as the condition of the transmission rule. In the button 716, a representative image 717 is displayed. The representative image 717 is an image representing the object category corresponding to the button 716. In the example in FIG. 7B, the image with the image ID of “IMG_005” is used as the representative image 717. The button 718 is arranged in the center of a right portion of the setting screen of the transmission rule. The button 718 has a function of instructing to include a case where the object category is “scenery” as the condition of the transmission rule. Therefore, with the user operating the button 718, it is possible to include a case where the object category is “scenery” as the condition of the transmission rule. In the button 718, a representative image 719 is displayed. The representative image 719 is an image representing the object category corresponding to the button 718. In the example in FIG. 7B, the image with the image ID of “IMG_007” is used as the representative image 719. Thus, the representative images 713, 715, 717 and 719 representing the object categories and the transmission rule identified for the corresponding object categories are displayed on the same display surface on the setting screen of the transmission rule. According to the display configuration as mentioned above, the user can confirm the images and the transmission rules on the same display surface, and thus the user can further easily figure out which object category conforms to which image in a case of setting the transmission rule. Next, an example in which the button 714 and the button 716 are operated by the user, and the transmission rules are set is described with reference to FIG. 7C.

FIG. 7C illustrates an example of the setting screen of the transmission rule. FIG. 7C illustrates an example in which an icon 721 and an icon 722 are arranged in addition to FIG. 7B. The icon 721 is arranged within a frame of the button 714. The icon 721 indicates that a case where the object category is “animal” is set as one of the conditions included in the setting of the transmission rule. The icon 722 indicates that a case where the object category is “vehicle” is set as one of the conditions included in the setting of the transmission rule. In a state in FIG. 7C, the setting of the transmission rule is completed by operating the button 711 illustrated in FIG. 7B. Thus, it is certain that a case where the object category is “animal” or “vehicle” is the condition included in the setting of the transmission rule.

FIG. 8A illustrates an example of the management screen of the transmission rule. The management screen of the transmission rule in FIG. 8A is different from the management screen of the transmission rule in FIG. 7A in that there is the transmission rule already set as “transmission rule 1”. As illustrated in FIG. 8A, the button 701 is arranged in the center of the lower portion of the management screen of the transmission rule. Since the function of the button 701 is similar to that in FIG. 7A, description thereof is omitted. The title of the screen that is “management of transmission rule” is arranged in the center of the upper portion of the management screen of the transmission rule. An icon with no outline that displays a character string “transmission rule 1” is displayed in a left region of a region between the button 701 and the title of the screen. This icon with no outline is in a state so as to be selectable by the user. A button 801 displaying a character string “delete” is displayed in a right region of the region between the button 701 and the title of the screen. The button 801 is in a state so as to be selectable by the user. The button 801 has a function of instructing to delete the set transmission rule. Therefore, it is possible to delete “transmission rule 1” with the user selecting the button 801. For example, in a case where the reception unit 204 receives an input indicating that the button 801 is tapped, the transmission rule setting unit 205 deletes the transmission rule stored in the storage unit 112.

FIG. 8B illustrates an example of an image list screen displaying a list of the images stored in the storage unit 112. As illustrated in FIG. 8B, thumbnails 811 to 814 are each arrayed at a regular interval in an upper portion of the image list screen. Additionally, thumbnails 815 to 817 are arrayed at regular intervals in a lower portion of the image list screen. Each of the thumbnails 811 to 817 indicates a thumbnail image corresponding to the image stored in the storage unit 112. In an example in FIG. 8B, each of the thumbnails 811 to 817 has a function of calling the image indicated by each image ID in FIG. 6A. For example, in a case where the thumbnail 811 is operated, it is possible to call the image corresponding to “IMG_001”. Therefore, in a case where the reception unit 204 receives an instruction to tap any one of the thumbnails 811 to 817, the screen generation unit 202 generates an action selection screen illustrated in FIG. 8C described later. Next, the screen in a case where the tap instruction is performed on the thumbnail 811 in FIG. 8B by an operation by the user is described with reference to FIG. 8C.

FIG. 8C is the action selection screen to select the action on the image. As illustrated in FIG. 8C, a preview image 821 is displayed in a region in a left portion of the action selection screen. The preview image 821 is a pre-output confirmation image of the image corresponding to the image ID of “IMG_001” that can be referred to from the thumbnail 811 in FIG. 8B is outputted. A printing button 822 is arrayed in a region in an upper right portion of the action selection screen. In a case where the printing button 822 is operated by the user, the instruction to print the image is performed. A mail transmission button 823 is arrayed in a region in a lower right portion of the action selection screen. In a case where the mail transmission button 823 is operated, the instruction to transmit the image with the mail is performed.

### [Flow of Processing of Displaying Setting Screen of Transmission Rule]

A flow of the processing of displaying the setting screen of the transmission rule by the information processing apparatus 101 is described below with reference to the flowcharts illustrated in FIGS. 2B, 4, and 5, the examples of the data in FIGS. 6A, 6B, and 6C, and the screen examples illustrated in FIGS. 7A and 7B. Note that, it is possible to implement the processing of displaying the setting screen of the transmission rule described below also as a cloud service that does not identify resources.

Hereinafter, a use case in which the storage unit 112 stores seven images in total that correspond to the image IDs indicated in the columns 601, 603, 605, 607, 609, 611, and 613 in FIG. 6A and the processing of displaying the setting screen of the transmission rule is performed is assumed. The flowchart illustrated in FIG. 2B is executed in a timing in which the management screen of the transmission rule illustrated in FIG. 7A is displayed by the CPU 151 functioning as the screen generation unit 202. In S211, the CPU 151 functioning as the reception unit 204 detects the pressing of the button 701, and a detection result thereof is received as input information from the user. In S212, the CPU 151 functioning as the screen generation unit 202 executes the processing in the flowchart in FIG. 4 to generate the setting screen of the transmission rule.

### (Detailed Processing in S212; Flowchart in FIG. 4)

In S401, the CPU 151 functioning as the association unit 209 obtains the seven images in total indicated in the columns 601, 603, 605, 607, 609, 611, and 613 in FIG. 6A from the storage unit 112. In S402, the CPU 151 functioning as the recognition unit 206 analyzes the object category of each image obtained in S401. An analyzed result is indicated as the object category arrayed in each of the columns 602, 604, 606, 608, 601, 612, and 614 in FIG. 6A.

### (Object Category: “Food”)

In S403, the CPU 151 functioning as the association unit 209 executes the processing illustrated in S404 to S408 by the number of the object categories. First, the processing is executed for a case where the object category is “food”. In S404, the CPU 151 functioning as the association unit 209 obtains the image with the image ID of “IMG_001” as the image that is consistent with a case where the object category is “food” out of the images identified by the image IDs in FIG. 6A. In S405, since the image obtained in S404 is the single image that is “IMG_001”, the CPU 151 allows the processing in S405 to proceed to the processing in S407. In S407, the CPU 151 functioning as the association unit 209 associates the image with the image ID of “IMG_001” with the object category “food”. In S408, the CPU 151 functioning as the associated image management unit 207 stores the image with the image ID of “IMG_001” and the object category “food” associated with each other in the storage unit 112. In S409, since the processing on all the object categories is not completed, the CPU 151 returns the processing in S409 to the processing in S403.

### (Object Category: “Animal”)

In S403, next, the processing is executed for the object category “animal”. In S404, the CPU 151 functioning as the association unit 209 obtains the images with the image ID of “IMG_002” and “IMG_003” as the images that are consistent with the object category “animal” out of the images in FIG. 6A. In S405, since two images are obtained “IMG_002” and “IMG_003” in S404, the CPU 151 allows the processing in S405 to proceed to the processing in S406. In S406, the CPU 151 functioning as the association unit 209 is executes the processing in the flowchart illustrated in FIG. 5 to select one of the multiple images.

### (Detailed Processing in S406; Flowchart in FIG. 5)

In S501, the CPU 151 functioning as the association unit 209 extracts the image that is consistent with the single object category. The image with the image ID of “IMG_002” is consistent with a case where the object category is “animal” as indicated in the column 604. The image with the image ID of “IMG_003” is consistent with a case where the object categories are “animal” and “vehicle” as indicated in the column 606. Accordingly, the CPU 151 functioning as the association unit 209 extracts the image with the image ID of “IMG_002” as the image that is consistent with the single object category. In S502, since the images are narrowed down to the single image “IMG_002” as a result of the processing in S501, the CPU 151 allows the processing in S502 to proceed to the processing in S508. In S508, the CPU 151 functioning as the association unit 209 selects the image with the image ID of “IMG_002” as the image to be displayed on the setting screen of the transmission rule and allows the processing in S508 to proceed to the processing in S407 in FIG. 4. In S407, the CPU 151 functioning as the association unit 209 associates the image with the image ID of “IMG_002” with the object category “animal”. In S408, the CPU 151 functioning as the associated image management unit 207 stores the image with the image ID of “IMG_002” and the object category “animal” associated with each other in the storage unit 112. In S409, since the processing on all the object categories is not completed, the CPU 151 returns the processing in S409 to the processing in S403.

### (Object Category: “Vehicle”)

In S403, next, the processing is executed for the object category “vehicle”. In S404, the CPU 151 functioning as the association unit 209 obtains the images with the image IDs of “IMG_003”, “IMG_004”, and “IMG_005” as the images that are consistent with the object category “vehicle” out of the images in FIG. 6A. In S405, since three images, which are “IMG_003”, “IMG_004”, and “IMG_005”, are obtained in S404, the CPU 151 allows the processing in S405 to proceed to the processing in S406. In S406, the CPU 151 functioning as the association unit 209 executes the processing in the flowchart illustrated in FIG. 5 to select one of the multiple images.

### (Detailed Processing in S406; Flowchart in FIG. 5)

In S501, the CPU 151 functioning as the association unit 209 extracts the image that is consistent with the single object category. The image with the image ID of “IMG_003” is consistent with the object categories “animal” and “vehicle” as indicated in the column 606. The image with the image ID of “IMG_004” is consistent with a case where the object category is “vehicle” as indicated in the column 608. The image with the image ID of “IMG_005” is consistent with a case where the object category is “vehicle” as indicated in the column 610. Accordingly, the CPU 151 functioning as the association unit 209 extracts the images with the image IDs of “IMG_004” and “IMG_005”. In S502, as a result of the processing in S501, the images are narrowed down to the two images, which are “IMG_004” and “IMG_005”; however, since the images are not narrowed down to one image, the CPU 151 allows the processing in S502 to proceed to the processing in S503. In S503, the CPU 151 functioning as the association unit 209 extracts the image with the image ID that is stored as the already-displayed image illustrated in FIG. 6B. First, since the image ID “IMG_004” is consistent with none of the image IDs indicated in the columns 631, 633, and 635, the image is not stored as the already-displayed image. Next, since the image ID “IMG_005” is consistent with the image ID indicated in the column 635, the image is stored as the already-displayed image. Accordingly, the CPU 151 functioning as the association unit 209 extracts the image with the image ID of “IMG_005”. In S504, as a result of the processing in S503, the images are narrowed down to the single image “IMG_005”. Therefore, the CPU 151 allows the processing in S504 to proceed to the processing in S508. In S508, the CPU 151 functioning as the association unit 209 selects “IMG_005” as the image to be displayed on the setting screen of the transmission rule and allows the processing in S508 to proceed to the processing in S407. In S407, the CPU 151 functioning as the association unit 209 associates the image with the image ID of “IMG_005” with the object category “vehicle”. In S408, the CPU 151 functioning as the associated image management unit 207 stores the image with the image ID of “IMG_005” and the object category “vehicle” associated with each other in the storage unit 201. In S409, since the processing on all the object categories is not completed, the CPU 151 returns the processing in S409 to the processing in S403.

### (Object Category: “Scenery”)

In S403, next, the processing is executed for the object category “scenery”. In S404, the CPU 151 functioning as the association unit 209 obtains the images with the image IDs of “IMG_006” and “IMG_007” from the images in FIG. 6A as the images that are consistent with the object category “scenery”. In S405, since two images, which are “IMG_006” and “IMG_007”, are obtained in S404, the CPU 151 allows the processing in S405 to proceed to the processing in S406. In S406, the CPU 151 functioning as the association unit 209 executes the processing in the flowchart illustrated in FIG. 5 to select one from the multiple images.

### (Detailed Processing in S406; Flowchart in FIG. 5)

In S501, the CPU 151 functioning as the association unit 209 extracts the image that is consistent with the single object category. The image with the image ID of “IMG_006” is consistent with a case where the object category is “scenery” as indicated in the column 612. The image with the image ID of “IMG_007” is consistent with a case where the object category is “scenery” as indicated in the column 614. Accordingly, the CPU 151 functioning as the association unit 209 extracts the image with the image ID of “IMG_006” and the image with the image ID of “IMG_007”. In S502, as a result of the processing in S501, the images are narrowed down to the two images “IMG_006” and “IMG_007”; however, since the images are not narrowed down to one image, the CPU 151 allows the processing in S502 to proceed to the processing in S503. In S503, the CPU 151 functioning as the association unit 209 extracts the image with the image ID that is stored as the already-displayed image illustrated in FIG. 6B. The image IDs “IMG_006” and “IMG_007” are consistent with none of the image IDs indicated in the columns 631, 633, and 635. Accordingly, the CPU 151 functioning as the association unit 209 extracts all the images, that is, the image IDs “IMG_006” and “IMG_007”. In S504, as a result of the processing in S503, the images are narrowed down to the two images “IMG_006” and “IMG_007”; however, since the images are not narrowed down to one image, the CPU 151 allows the processing in S504 to proceed to the processing in S505. In S505, the CPU 151 functioning as the association unit 209 extracts the image with the image ID that is stored as the action-executed-already image illustrated in FIG. 6C. The image ID “IMG_006” does not match the image ID indicated in the column 641. The image ID “IMG_007” matches the image ID indicated in the column 641. Accordingly, the CPU 151 functioning as the association unit 209 extracts the image with the image ID of “IMG_007”. In S506, as a result of the processing in S505, the images are narrowed down to the one image, which is “IMG_007”; for this reason, the CPU 151 allows the processing in S506 to proceed to the processing in S508. In S508, the CPU 151 functioning as the association unit 209 selects the image with the image ID of “IMG_007” as the image to be displayed on the setting screen of the transmission rule and allows the processing in S508 to proceed to the processing in S407. In S407, the CPU 151 functioning as the association unit 209 associates the image with the image ID of “IMG_007” with the object category “scenery”. In S408, the CPU 151 functioning as the associated image management unit 207 stores the image with the image ID of “IMG_007” and the object category “scenery” associated with each other in the storage unit 112. In S409, since the processing on all the object categories is completed, the CPU 151 allows the processing in S409 to proceed to the processing in S410. In S410, the CPU 151 functioning as the screen generation unit 202 generates the setting screen of the transmission rule illustrated in FIG. 7B and allows the processing in S410 to proceed to the processing in S213. In S213, the CPU 151 functioning as the screen generation unit 202 presents the setting screen of the transmission rule to the user and ends the present processing that is the processing of displaying the setting screen of the transmission rule.

With the processing thus far, in S407, the CPU 151 functioning as the association unit 209 associates the image with the image ID of “IMG_001” with the object category “food”. Accordingly, the CPU 151 functioning as the screen generation unit 202 uses the image with the image ID of “IMG_001” as the representative image 713 of the button 712 designating the object category “food” as the transmission rule. Additionally, in S407, the CPU 151 functioning as the association unit 209 associates the image with the image ID of “IMG_002” with the object category “animal”. Accordingly, the CPU 151 functioning as the screen generation unit 202 uses the image with the image ID of “IMG_002” as the representative image 715 of the button 714 designating the object category “animal” as the transmission rule. Moreover, in S407, the CPU 151 functioning as the association unit 209 associates the image with the image ID of “IMG_005” with the object category “vehicle”. Accordingly, the CPU 151 functioning as the screen generation unit 202 uses the image with the image ID of “IMG_005” as the representative image 717 as the button 716 designating the object category “vehicle” as the transmission rule. Furthermore, in S407, the CPU 151 functioning as the association unit 209 associates the image with the image ID of “IMG_007” with the object category “scenery”. Accordingly, the CPU 151 functioning as the screen generation unit 202 uses the image with the image ID of “IMG_007” as the representative image 719 of the button 718 designating the object category “scenery” as the transmission rule.

According to the above descriptions, the CPU 151 receives the setting of the transmission rule by the user via the setting screen managing the setting to transmit the image. The CPU 151 selects the image to be paired with the transmission rule from the image associated with the user. The CPU 151 associates the selected image with the transmission rule. The CPU 151 makes display the selected image and the transmission rule on the setting screen as associated relevant information. With the above-mentioned operation, the user can confirm the image paired with the transmission rule. Since the image paired with the transmission rule is the image selected from the image associated with the user, the image displayed on the setting screen is the image related to the user and the transmission rule. Accordingly, the image displayed on the setting screen can provide the user with a hint of the setting of the transmission rule. Thus, it is possible to assist the setting of the transmission rule. That is, the user can intuitively understand the transmission rule by visually confirming the image displayed on the setting screen. Thus, in a case where the user sets the transmission rule, it is possible to easily figure out which image conforms to which object category.

Additionally, the CPU 151 may obtain the image associated with the user from an image that has been displayed on the setting screen based on the transmission rule. With the above-mentioned operation, the image that is already used for displaying is associated, and thus it is easy for the user to see which image is to be transmitted.

Moreover, in a case where multiple images are associated with the user and conform to the condition included in the setting of the transmission rule, the CPU 151 may select an image that has been associated with the transmission rule. With the above-mentioned operation, it is possible to set the image that has been selected from the multiple images in the past as the representative image displayed on the setting screen. Thus, it is possible to provide an interface easily understandable by the user.

Furthermore, in a case where multiple images are associated with the user and conform to the condition included in the setting of the transmission rule, the CPU 151 may select an image with the oldest capturing date and time. With the above-mentioned operation, the image with the oldest capturing date and time is selected. The image with the oldest capturing date and time that remains without being deleted suggests a possibility that the image is frequently used; therefore, it is possible to set the transmission rule with higher practicality by selecting the image.

Additionally, in a case where multiple images are associated with the user and conform to the condition included in the setting of the transmission rule, the CPU 151 may select an image with less object categories. With the above-mentioned operation, it is possible to narrow down the representative images; therefore, in a case where the user sets the transmission rule, it is possible to further easily figure out which image conforms to which object category.

Moreover, in a case where multiple images are associated with the user and conform to the condition included in the setting of the transmission rule, the CPU 151 may select an image on which the action set in advance has been already executed. With the above-mentioned operation, it is possible to narrow down the representative images to the image on which the action has been already executed; therefore, it is possible to set the transmission rule with higher practicality.

Furthermore, the CPU 151 may set the arrangement place of the image and the arrangement place of the transmission rule on the same surface of the setting screen of the transmission rule. With the above-mentioned operation, it is possible to confirm the image and the transmission rule on the same surface; therefore, in a case where the user sets the transmission rule, it is possible to further easily figure out which image conforms to which object category.

### [Flow of Processing of Setting Transmission Rule]

A flow of the processing of setting the transmission rule by the information processing apparatus 101 is described below with reference to the examples of the setting screen illustrated in FIGS. 7B and 7C. The present processing is executed in a timing in which the CPU 151 functioning as the screen generation unit 202 displays the setting screen illustrated in FIG. 7B. Note that, it is possible to implement the processing of displaying the setting screen of the transmission rule described below also as a cloud service that does not identify resources.

The CPU 151 functioning as the reception unit 204 executes the following operations in a case where an input instruction to tap the button 714 is received from the terminal 102. That is, the CPU 151 functioning as the screen generation unit 202 displays the icon 721 as illustrated in FIG. 7C. This indicates that the object category “animal” is selected as the transmission rule. Additionally, the CPU 151 functioning as the reception unit 204 executes the following operations in a case where an input instruction to tap the button 716 is received from the terminal 102. That is, the CPU 151 functioning as the screen generation unit 202 displays the icon 722. This indicates that the object category “vehicle” is selected as the transmission rule.

### [Flow of Processing of Completing Setting of Transmission Rule]

A flow of the processing of completing the setting of the transmission rule by the information processing apparatus 101 is described below with reference to the flowchart illustrated in FIG. 2C, the example of the data in FIG. 6E, and the screen example illustrated in FIG. 7C. The present processing is executed in a timing in which the CPU 151 functioning as the screen generation unit 202 displays the screen illustrated in FIG. 7C. Note that, it is possible to implement the processing of completing the setting of the transmission rule described below also as a cloud service that does not identify resources.

In S221, the CPU 151 functioning as the reception unit 204 receives an input instruction to tap the button 711 from the terminal 102. In S222, the CPU 151 functioning as the transmission rule setting unit 205 determines that “animal” and “vehicle” are selected as the object categories in a case where the button 711 is operated. Therefore, the CPU 151 determines that one or more object categories are selected and allows the processing in S222 to proceed to the processing in S223. In S223, the CPU 151 functioning as the transmission rule setting unit 205 stores the transmission rule indicating the transmission of the image matching the object category “animal” or “vehicle” in the storage unit 112 and ends the present processing. FIG. 6E illustrates the transmission rule stored in the present step. Note that, in S221, in a case of receiving the input instruction to tap the button 711 in a state of the screen illustrated in FIG. 7B, that is, in a state in which no object category is selected, the CPU 151 functioning as the reception unit 204 performs the following operations. That is, in S222, since no object category is selected, the CPU 151 functioning as the transmission rule setting unit 205 ends the present processing.

### [Flow of Processing of Transmitting Image]

A flow of the processing of transmitting the image by the information processing apparatus 101 is described below with reference to the flowchart illustrated in FIG. 3A and the examples of the data in FIGS. 6D and 6E. Here, flows of executing the transmission processing on the three images illustrated in FIG. 6D are described sequentially. Here, the transmission processing is the processing of transmitting the transmission candidate image in a case where the information obtained from the transmission candidate image conforms to the condition of the transmission rule. Therefore, in a case where the information obtained from the transmission candidate image does not conform to the condition included in the setting of the transmission rule, no transmission candidate image is transmitted. Note that, it is possible to implement the processing of displaying the setting screen of the transmission rule described below also as a cloud service that does not identify resources.

Hereinafter, a use case in which the storage unit 112 stores the object categories indicated in the columns 661 and 662 in FIG. 6E as the transmission rule is assumed.

### (Processing of Transmitting Image “IMG_101”)

First, a flow of executing the transmission processing on the image with the image ID of “IMG_101” in the column 651 is described. In S301, the CPU 151 functioning as the recognition unit 206 analyzes the object category of the image newly stored in the storage unit 112. The analyzed result is the object category “vehicle” indicated in the column 652 in FIG. 6D. In S302, the CPU 151 functioning as the transmission unit 203 obtains the transmission rule illustrated in FIG. 6E. As indicated in the column 661 and the column 662, the obtained transmission rule includes “animal” and “vehicle” as the object categories. In S303, the CPU 151 functioning as the transmission unit 203 determines that the object category “vehicle” analyzed in S301 is included in the transmission rule obtained in S302. The CPU 151 allows the processing in S303 to proceed to the processing in S304. In S304, the CPU 151 functioning as the transmission unit 203 transmits the image with the image ID of “IMG_101” to the image management service 103. Thus, in a case where the analyzed object category is included in the transmission rule, the image in which the object characterized by the object category appears is transmitted. That is, in a case where the candidate category characterizing the candidate object appearing in the transmission candidate image is consistent with the object category and the information thus obtained from the transmission candidate image conforms to the condition included in the setting of the transmission rule, the transmission candidate image is transmitted.

### (Processing of Transmitting Image “IMG_102”)

Next, a flow of executing the transmission processing on the image with the image ID of “IMG_102” in the column 653 is described. In S301, the CPU 151 functioning as the recognition unit 206 analyzes the object category of the image newly stored in the storage unit 112. The analyzed result is the object category “scenery” indicated in the column 654 in FIG. 6D. In S302, the CPU 151 functioning as the transmission unit 203 obtains the transmission rule illustrated in FIG. 6E. As indicated in the column 661 and the column 662, the obtained transmission rule includes “animal” and “vehicle” as the object categories. In S303, the CPU 151 functioning as the transmission unit 203 determines that the object category “scenery” analyzed in S301 is not included in the transmission rule obtained in S302. The CPU 151 ends the processing in S303 and ends the present processing. Thus, in a case where the analyzed object category is not included in the transmission rule, the image in which the object characterized by the object category is not transmitted. That is, in a case where the candidate category characterizing the candidate object appearing in the transmission candidate image is not consistent with the object category and the information thus obtained from the transmission candidate image does not conform to the condition included in the setting of the transmission rule, no transmission candidate image is transmitted.

### (Processing of Transmitting Image “IMG_103”)

Next, a flow of executing the transmission processing on the image with the image ID of “IMG_103” in the column 655 is described. In S301, the CPU 151 functioning as the recognition unit 206 analyzes the object category of the image newly stored in the storage unit 112. The analyzed result is a result that corresponds to none of the object categories as indicated in the column 656 in FIG. 6D. In S302, the CPU 151 functioning as the transmission unit 203 obtains the transmission rule illustrated in FIG. 6E. As indicated in the column 661 and the column 662, the obtained transmission rule includes “animal” and “vehicle” as the object categories. In S303, since no corresponding object category is obtained in S301, the CPU 151 functioning as the transmission unit 203 determines that the object category is not included in the transmission rule obtained in S302 and ends the present processing. Thus, in a case where the analyzed object category is not included in the transmission rule, the image in which the object characterized by the object category appears is not transmitted. That is, in a case where the candidate category characterizing the candidate object appearing in the transmission candidate image is not consistent with the object category and the information thus obtained from the transmission candidate image does not conform to the condition included in the setting of the transmission rule, no transmission candidate image is transmitted.

According to the above descriptions, in a case where the object category characterizing the object appearing in the image and the candidate category characterizing the candidate object appearing in the transmission candidate image are consistent with each other as the setting of the transmission rule, the CPU 151 may receive the setting of the transmission processing to transmit the transmission candidate image. With the above-mentioned operation, it is possible to perform the transmission processing of the transmission candidate image in which there appears the candidate object characterized by the candidate category that is consistent with the object category characterizing the object appearing in the image. Therefore, it is possible to set the transmission processing with a further intuitive operation. Additionally, the CPU 151 may display the image that is a part of the relevant information associated for each object category as a part of the transmission rule. With the above-mentioned operation, since the image displayed on the setting screen is associated for each object category, it is possible to set the transmission processing with a further intuitive operation.

### [Flow of Processing of Executing Action]

A flow of the processing of executing the action by the information processing apparatus 101 is described below with reference to the flowchart illustrated in FIG. 3B, the example of the data illustrated in FIG. 6A and the screen example illustrated in FIG. 8C. The present processing is executed in a timing in which the CPU 151 functioning as the screen generation unit 202 displays the screen illustrated in FIG. 8C. Note that, it is possible to implement the processing of executing the action described below as a cloud service that does not identify resources.

Hereinafter, a use case in which the storage unit 112 stores the seven images in total that correspond to the image IDs indicated in the columns 601, 603, 605, 607, 609, 611, and 613 in FIG. 6A and the processing of executing the action is performed is assumed.

### (“Printing” Action)

First, a flow of the processing of executing the “printing” action is described. In S311, the CPU 151 functioning as the reception unit 204 receives an execution instruction indicating that the printing button 822 is tapped. In S312, since the received execution instruction is “printing”, the CPU 151 allows the processing in S312 to proceed to the processing in S313. In S313, the CPU 151 functioning as the execution unit 208 transmits the image with the image ID of “IMG_001” that corresponds to the preview image 821 to the image formation apparatus via the communication unit 111. Here, the image formation apparatus may be an apparatus included in the information processing system or may be an apparatus arranged outside the information processing system. In S314, the CPU 151 functioning as the execution unit 208 stores information indicating that the action “printing” has been already executed on the image corresponding to the image ID “IMG_001” in the storage unit 112. For example, as illustrated in FIG. 6C, the image ID and the already-executed action are stored in association with each other. In S315, since the received execution instruction is “printing”, the CPU 151 ends the present processing.

### (“Mail Transmission” Action)

Next, a flow of the processing of executing a “mail transmission” action is described. In S311, the CPU 151 functioning as the reception unit 204 receives an execution instruction indicating that the mail transmission button 823 is tapped. In S312, since the received execution instruction is “mail transmission”, the CPU 151 allows the processing in S312 to proceed to the processing in S315. In S315, since the received execution instruction is “mail transmission”, the CPU 151 allows the processing in S315 to proceed to the processing in S316. In S316, the CPU 151 functioning as the execution unit 208 transmits the image with the image ID of “IMG_001” that corresponds to the preview image 821 to the mail server via the communication unit 111. Here, the mail server may be a mail server included in the information processing system, a mail server arranged outside the information processing system, or a mail server implemented as a cloud service that does not identify resources. In S317, once the CPU 151 functioning as the execution unit 208 stores information indicating that the action “mail transmission” has been already executed on the image corresponding to the image ID “IMG_001” in the storage unit 112, the CPU 151 ends the present processing.

According to the above descriptions, in a case where multiple images are associated with the user and conform to the condition included in the setting of the transmission rule, the CPU 151 may determine an image on which the printing has been executed as an image on which the action set in advance has been already executed. With the above-mentioned operation, the images are narrowed down to an image that is demanded to be outputted to a paper medium, and thus it is possible to set the transmission rule with higher practicality.

Additionally, in a case where multiple images are associated with the user and conform to the condition included in the setting of the transmission rule, the CPU 151 may determine the image on which the transmission with e-mail has been executed as the image on which the action set in advance has been already executed. With the above-mentioned operation, the images are narrowed to an image that is demanded to be transmitted with e-mail, and thus it is possible to set the transmission rule with higher practicality.

As above, in the present embodiment, based on a result of the recognition of the image owned by the user, the image is displayed on the setting screen of the transmission rule. In this case, the image owned by the user may be the image associated with the user. The image associated with the user is, for example, an image that is captured by the image capturing apparatus 109 and held inside the image capturing apparatus 109. Additionally, the image saved in the cloud storage service of the image by the user is also the image associated with the user. That is, the image associated with the user may be an image related to the user directly or indirectly. Moreover, the transmission rule in the present embodiment is to transmit the transmission candidate image in a case where the object category characterizing the object appearing in the image and the candidate category characterizing the candidate object appearing in the transmission candidate image are consistent with each other. Furthermore, the image displayed on the setting screen of the transmission rule is the image in which the object characterized by the object category appears and is the image owned by the user. That is, it is possible to improve the convenience of the user by presenting the characteristic of the image that is consistent with each object category, which is the condition of the transmission rule, by using the image owned by the user. Additionally, here, the consistency does not necessarily mean perfect matching. For example, the consistency is achieved as long as an element indicating the candidate category is included in a region identifying the object category as a result of categorization using an algorithm such as a support vector machine and it is possible to assume that the object category matches the candidate category.

Note that, the information processing apparatus 101 may communicate with the multiple image management services 103. The CPU 151 functioning as the screen generation unit 202 may generate a screen to designate the transmission destination for the transmission rule to designate to which image management service 103 the image that is consistent with the transmission rule is to be transmitted. The CPU 151 functioning as the transmission unit 203 may transmit the image that is consistent with the transmission rule to the designated image management service 103.

Alternatively, in a case where none of the images stored in the storage unit 112 are consistent with a specific object category, an image prepared in advance may be used as the representative image. Alternatively, the processing of transmitting the image may be executed in a timing other than a timing in which a new image is stored in the storage unit 112. For example, the information processing apparatus 101 may include an image capturing unit and execute the processing of transmitting the image in a timing in which the image capturing unit captures an image. Additionally, for example, the information processing apparatus 101 may include an image generation unit and execute the processing of transmitting the image in a timing in which the image generation unit generates an image. Alternatively, the CPU 151 functioning as the screen generation unit 202 may generate an editing screen to edit contents of the created transmission rule. Alternatively, the CPU 151 functioning as the screen generation unit 202 may generate a screen to set multiple transmission rules. Alternatively, a screen to set a name of the transmission rule may be generated. Alternatively, the CPU 151 functioning as the screen generation unit 202 may generate a screen to delete the image stored in the storage unit 112. In a case where the CPU 151 functioning as the reception unit 204 receives an input indicating the deletion of the image, the storage unit 112 may delete the corresponding image and may delete the image ID of the image from the already-displayed image and the action-executed-already image. Alternatively, the object category recognized by the CPU 151 functioning as the recognition unit 206 may be an object category other than “food”, “animal”, “vehicle”, and “scenery”. Alternatively, the CPU 151 functioning as the recognition unit 206 may cache a result of the recognition processing to the storage unit 112. In a case where the recognition of one image is requested again, a result cached to the storage unit 112 may be returned instead of executing the recognition processing and returning a result thereof. In this case, although caching is described under the assumption that the HTTP protocol is used, the protocol used is not particularly limited thereto. For example, a controller area network (CAN) protocol that is used in an in-vehicle device in the communication between vehicles may be applicable. Alternatively, a consultative committee for space data systems (CCSDS)-TC protocol used in the satellite communication and the like may be applicable. Alternatively, the action executed by the CPU 151 functioning as the execution unit 208 may be an action other than “printing” and “mail transmission”. Alternatively, the CPU 151 functioning as the screen generation unit 202 may generate a screen to designate the image formation apparatus as a destination and a transmission destination of a mail. Alternatively, in a case where not all the object categories are selected on the setting screen of the transmission rule illustrated in FIGS. 7B and 7C, the CPU 151 functioning as the screen generation unit 202 may display an error. Alternatively, in a case where not all the object categories are selected on the setting screen of the transmission rule illustrated in FIGS. 7B and 7C, the CPU 151 functioning as the screen generation unit 202 may deactivate the button 711. Thus, it is possible to make a state unresponsive even with an operation such as tapping on the button 711.

### Modification of First Embodiment

As a modification of the present embodiment, the CPU 151 functioning as the screen generation unit 202 may not display the representative image indicating each object category on the setting screen of the transmission rule. Instead, the CPU 151 functioning as the screen generation unit 202 may display the representative image of each object category in a case where a help button corresponding to each object category is tapped.

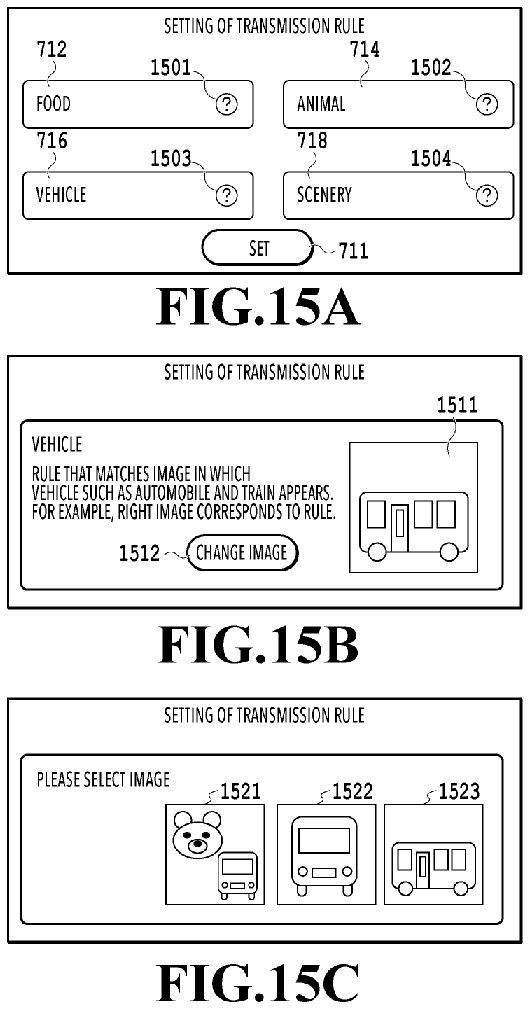

FIG. 15A is an example of the setting screen of the transmission rule in the modification of the present embodiment. As illustrated in the example of the present setting screen, the setting screen of the transmission rule displays no representative image indicating each object category. Instead, help buttons 1501 to 1504 are displayed. FIG. 15B illustrates a screen example in which the CPU 151 functioning as the reception unit 204 receives information indicating that the help button 1503 is tapped on the setting screen of the transmission rule in FIG. 15A. The screen example in FIG. 15A is a screen generated by the CPU 151 functioning as the screen generation unit 202. In FIG. 15B, a preview image 1511 and a change button 1512 are arranged. The preview image 1511 is arranged in a right portion of the screen. The preview image 1511 is the representative image corresponding to the object category “vehicle”. The preview image 1511 corresponds to a pre-output confirmation image of the image with the image ID of “IMG_005”. The change button 1512 is arranged in the center of a lower portion of the screen. The change button 1512 is a change button of the representative image. In a case where the CPU 151 functioning as the reception unit 204 receives information indicating that the change button 1512 is tapped, the CPU 151 functioning as the screen generation unit 202 generates a screen to display the candidate of the representative image. In the modification of the present embodiment, the candidate of the representative image is an image included in an image group matching the object category “vehicle”. FIG. 15C illustrates an example of the candidate of the representative image. Preview images 1521 to 1523 are images that are consistent with the object category “vehicle” and correspond to the image IDs “IMG_003”, “IMG_004”, and “IMG_005”, respectively. In a case where the CPU 151 functioning as the reception unit 204 receives information indicating that the preview images 1521 to 1523 are tapped, the CPU 151 functioning as the screen generation unit 202 changes the representative image to the tapped image.

Note that, in the present modification, the CPU 151 functioning as the screen generation unit 202 may display a part of each image included in the image group that is consistent with the object category as the candidate of the representative image. Particularly, in a case where the images included in the image group include an image similar to the image belonging to the object category before changing, some of the images may be displayed as the candidates. For example, a case where there are 100 images that are consistent with the object category “animal” and 90 images thereof are similar to the image belonging to the object category before changing is assumed. In a case of this assumption, one of these 90 images may be selected to be added with the remaining 10 images, and the 11 images in total may be displayed as the candidates of the representative image.

According to the above descriptions, the setting screen may include multiple hierarchies, and the transmission rule may be displayed on a lower hierarchy than a hierarchy of the image associated with the user out of the multiple hierarchies.

### Second Embodiment

In the first embodiment, the CPU 151 functioning as the recognition unit 206 recognizes the category of the object appearing in the image. In the present embodiment, the CPU 151 functioning as the recognition unit 206 recognizes a blur evaluation value indicating a degree of a blur included in the image. In other words, instead of using the object category as the transmission rule in the first embodiment, the blur evaluation value is used as the transmission rule in the second embodiment.

### [Overall Configuration]

A configuration of the information processing system in the present embodiment is similar to that in FIGS. 1A to 1D in the first embodiment; for this reason, description thereof is omitted. That is, the network constituents included in the information processing system are connectable to each other via the Internet 100. Likewise, in the present embodiment, the network constituents include, for example, the information processing apparatus 101, the terminal 102, the image management services 103_1 and 103_2, and the image capturing apparatus 109.

### [Software Configuration]

A software configuration in the present example is as illustrated in FIG. 2A. That is, the various types of software of the information processing apparatus 101 are implemented as functional blocks with the CPU 151 executing a program according to the present embodiment. Alternatively, it is possible to implement various programs according to the present embodiment also as a configuration of cloud computing that shares one function with multiple resources and performs processing in cooperation via the Internet 100.

### [Processing of Presenting Setting Screen of Transmission Rule]

The processing of presenting the setting screen of the transmission rule in the present embodiment is as illustrated in FIG. 2B. That is, the setting screen of the transmission rule is generated via the setting screen of the transmission rule, the generated setting screen of the transmission rule is displayed on the terminal 102, for example, and accordingly the setting screen of the transmission rule is presented to the user operating the terminal 102.

### [Processing of Setting Transmission Rule]

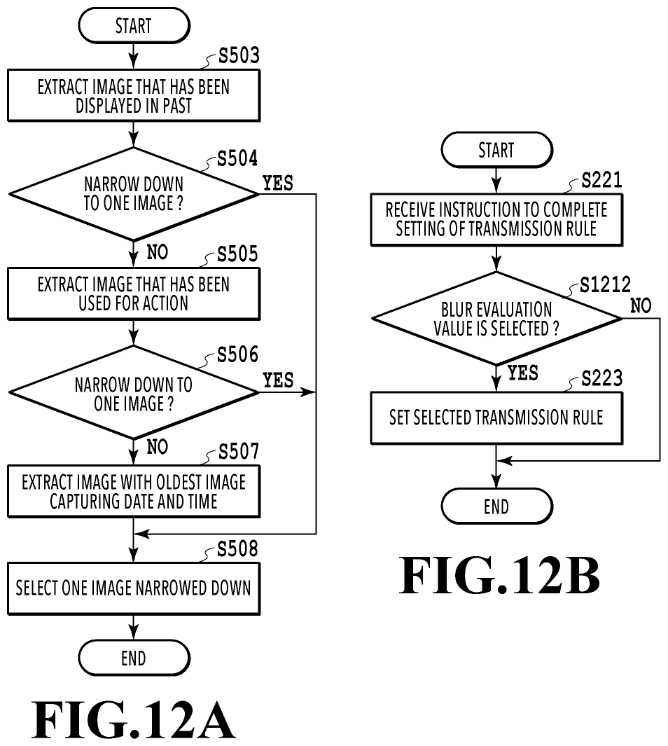

FIG. 12 is a flowchart illustrating an example of an operation of the information processing apparatus 101. FIG. 12B is a flowchart illustrating an example of the processing of setting the transmission rule that is executed by the information processing apparatus 101. The processing illustrated in FIG. 12B is implemented with the computation unit 113 of the information processing apparatus 101 executing the program stored in the storage unit 112. The processing illustrated in 12B is executed in a timing in which the screen generation unit 202 generates the setting screen of the transmission rule. Note that, the processing illustrated in FIG. 12B is different from the processing illustrated in FIG. 2C in that there is the processing in S1212. Here, the processing in S1212 is described. In S1212, the CPU 151 functioning as the transmission rule setting unit 205 determines whether the blur evaluation value is selected. If the blur evaluation value is selected, the CPU 151 allows the processing in S1212 to proceed to the processing in S223. If no blur evaluation value is selected, the CPU 151 ends the present flowchart including the processing from S221, S1212, and S223. Note that, details of the blur evaluation value are described later.

### [Processing of Transmitting Image]

The processing of transmitting the image in the present example is as illustrated in FIG. 3A. That is, in a case where it is determined that the transmission candidate image satisfies the transmission rule, the CPU 151 transmits the transmission candidate image to the image management service 103.

### [Processing of Executing Action]

The processing of executing the action in the present example is as illustrated in FIG. 3B. That is, in a case where the action that is printing or the action that is mail transmission is performed, the CPU 151 stores the image ID corresponding to the image on which the action is executed.

### [Detailed Generation Method of Setting Screen of Transmission Rule]

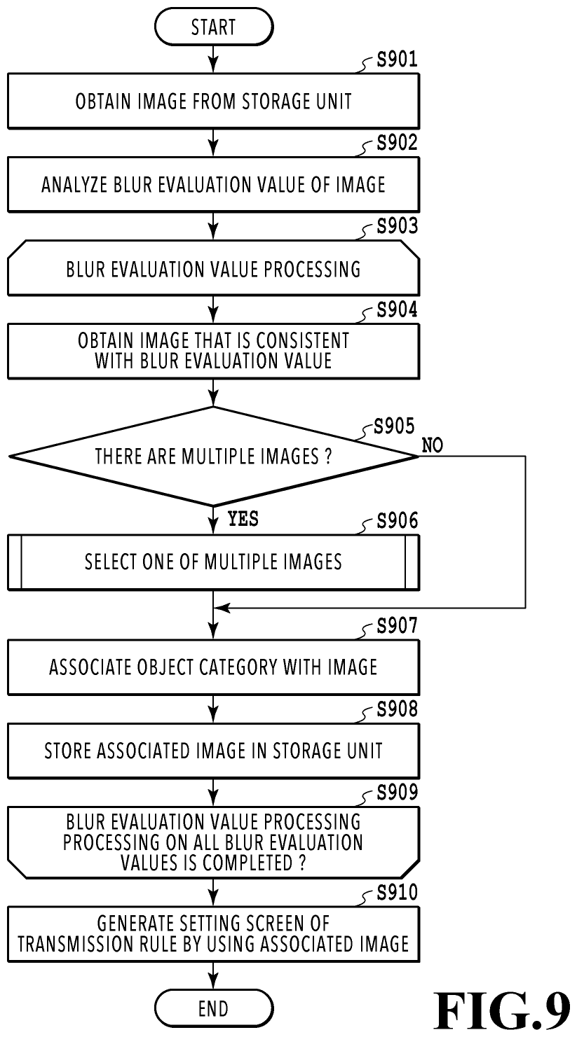

FIG. 9 is a flowchart illustrating an example of an operation of the information processing apparatus 101. FIG. 9 illustrates details of the processing in S212. Specifically, the processing from S901 to S910 in FIG. 9 is the processing of generating the setting screen of the transmission rule. The processing illustrated in FIG. 9 is implemented with the computation unit 113 of the information processing apparatus 101 executing the program stored in the storage unit 112. The processing illustrated in FIG. 9 is executed in a timing in which the processing in S212 in FIG. 2B is called. That is, the processing illustrated in FIG. 9 is implemented by the CPU 151. Note that, a part of or all the functions of steps in FIG. 9 may be implemented by hardware such as an ASIC or an electronic circuit. A sign “S” in description of each processing means that it is a step in the corresponding flowchart. Additionally, it is possible to implement the processing illustrated in FIG. 9 also as a configuration of cloud computing that shares one function with multiple resources and performs processing in cooperation via the Internet 100. Note that, in the present embodiment, the blur evaluation value is used as the condition included in the setting of the transmission rule. Therefore, the processing illustrated in FIG. 9 is processing of selecting the image to be displayed on the setting screen of the transmission rule based on the blur evaluation value. In a case where there are multiple options for the image based on the blur evaluation value, one image is selected from the multiple images by the processing illustrated in FIG. 12 described later.

In S901, the CPU 151 functioning as the association unit 209 obtains the image from the storage unit 112. Here, the obtained image may not be the image stored in the storage unit 112. The obtained image may be the image that can be taken from the storage service. In S902, the CPU 151 functioning as the recognition unit 206 analyzes the blur evaluation value of the image obtained in S901. In this case, the analysis of the blur evaluation value is an operation to quantify the blur in the image obtained in S901 in multiple levels and identify which level the blur is categorized. For example, an edge of the object appearing in the image may be detected by applying an edge detection filter such as a Laplacian filter to the image as an analysis target. In addition, as a difference between luminance values of adjacent pixels is greater, the detected edge of the object is greater. Therefore, the degree of the edge may be determined by setting thresholds at multiple levels proportional to the degrees of the edge in advance and determining the detected edge based on the each set threshold. As the degree of the edge is smaller, the degree of the blur is greater. Therefore, the blur in the image may be categorized by the blur evaluation value by setting the blur evaluation value corresponding to the each threshold and categorizing the degree of the edge into levels by the blur evaluation value. Note that, the blur evaluation value in the present embodiment has any one of values “0”, “1”, “2”, and “3”. This indicates that the blur included in the image is smaller as the evaluation value is greater. In S903, the CPU 151 functioning as the association unit 209 executes the processing illustrated in S904 to S908 by the number of the blur evaluation values. That is, since the processing from S904 to S908 is executed for each designated blur evaluation value, in a case where there are four blur evaluation values as described above, the processing from S904 to S908 is executed four times in total. In S904, based on the blur evaluation value of the image that is obtained in S902, the CPU 151 functioning as the association unit 209 obtains the image that is consistent with the blur evaluation value designated in S903 out of the images obtained in S901. In S905, the CPU 151 functioning as the association unit 209 determines whether multiple images are obtained in S904. If multiple images are obtained, the CPU 151 allows the processing in S905 to proceed to the processing in S906. If multiple images are not obtained, the CPU 151 allows the processing in S905 to proceed to the processing in S907. Here, a case where multiple images are obtained means that there are multiple images that are consistent with a specific blur evaluation value. For example, it is a case where there are multiple images that are consistent with the blur evaluation value “0”. In S906, the CPU 151 functioning as the association unit 209 selects one image from the multiple images. Details of the processing in S906 are illustrated in FIG. 12A. The processing illustrated in FIG. 12A is similar to the processing from S503 to S508 in FIG. 5; for this reason, in the present embodiment, description thereof is omitted. In S907, if one image is obtained in S904, the CPU 151 functioning as the association unit 209 associates the image with the blur evaluation value designated in S903. If multiple images are obtained in S904, the CPU 151 associates the image selected in S906 with the blur evaluation value designated in S903. In S908, the CPU 151 functioning as the associated image management unit 207 stores the image ID of the image associated in S907 in the storage unit 112 as the already-associated image. In S909, in a case where the processing on the blur evaluation value is all completed, the CPU 151 allows the processing in S909 to proceed to the processing in S910. On the other hand, in a case where the processing on the blur evaluation value is not all completed, the CPU 151 returns the processing in S909 to the processing in S903. In S910, the CPU 151 functioning as the screen generation unit 202 generates the setting screen of the transmission rule by using the associated image and ends the present flowchart including the processing from S901 to S910. The CPU 151 functioning as the screen generation unit 202 uses the image associated with each blur evaluation value by the CPU 151 functioning as the association unit 209 in S907 to generate the setting screen of the transmission rule.

### [Example of Data]

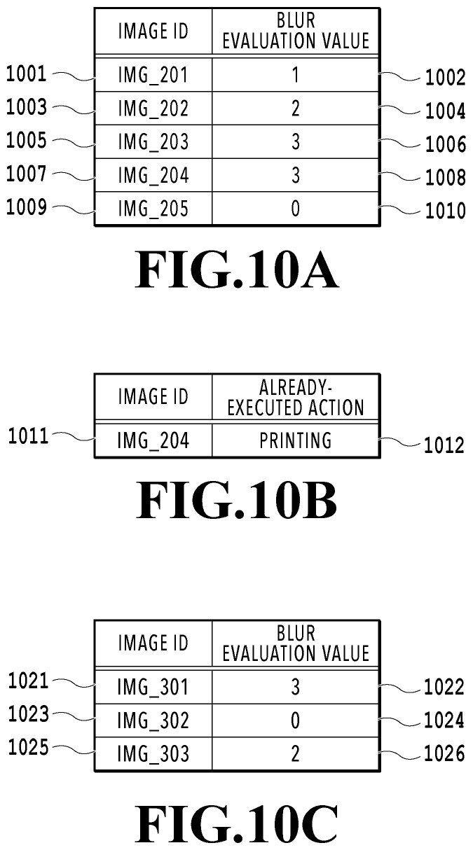

FIG. 10A illustrates a result of the analysis processing in S902. That is, FIG. 10A illustrates the blur evaluation value for each image that is obtained with the recognition unit 206 analyzing each image. In a column of the image ID, information of the image ID is indicated as an identifier that can uniquely identify each image. In a column of the blur evaluation value, the blur evaluation value categorizing the blur of each image into levels is indicated. That is, FIG. 10A illustrates a data set in which the image and the blur evaluation value are associated with each other. Note that, in the column of the blur evaluation value, a specific blur evaluation value ID may be arrayed as an identifier that can uniquely identify each blur evaluation value. In the present embodiment, for the sake of convenient description, in FIG. 10A, a number that allows for intuitive understanding of the blur evaluation value categorized into levels, such as “0”, “1”, “2”, and “3”, is arrayed. The data set in which the image and the blur evaluation value are associated with each other is as follows, specifically. In a column 1001 of the image ID, information that is “IMG_201” is arrayed. In a column 1002 of the blur evaluation value adjacent to the column 1001 of the image ID, information indicating the blur evaluation value identified by “1” is arrayed. In a column 1003 of the image ID, information that is “IMG_202” is arrayed. In a column 1004 of the blur evaluation value adjacent to the column 1003 of the image ID, information indicating the blur evaluation value identified by “2” is arrayed. In a column 1005 of the image ID, information that is “IMG_203” is arrayed. In a column 1006 of the blur evaluation value adjacent to the column 1005 of the image ID, information indicating the blur evaluation value identified by “3” is arrayed. In a column 1007 of the image ID, information that is “IMG_204” is arrayed. In a column 1008 of the blur evaluation value adjacent to the column 1007 of the image ID, information indicating the blur evaluation value identified by “3” is arrayed. In a column 1009 of the image ID, information that is “IMG_205” is arrayed. In a column 1010 of the blur evaluation value adjacent to the column 1009 of the image ID, information indicating the blur evaluation value identified by “0” is arrayed. Therefore, it is indicated that the analyzed results of the blurs in the images identified by IMG_203 and IMG_204 out of IMG_201 to IMG_205 are “3” as the same blur evaluation values.

FIG. 10B illustrates data used for the processing in S908. That is, FIG. 10B illustrates information of a pair of the image ID and the already-executed action expected to be stored in the storage unit 112 by the execution unit 208. Therefore, FIG. 10B illustrates the information of the pair of the image ID and the already-executed action that is obtained by the processing from S311 to S313. For example, in a column 1011 of the image ID, the information that is “IMG_204” is arrayed. In a column 1012 of the already-executed action adjacent to the column 1011 of the image ID, the information that is “printing” is arrayed as the information indicating that the image identified by “IMG_204” has been used to execute the “printing” action. Note that, as long as the image ID is associated with the information indicating that it is the already-executed action, any data configuration may be applicable. Therefore, a data configuration in which the column of the already-executed action can be referred to from the column of the image ID in FIG. 10A may be applicable. Alternatively, the column of the already-executed action may be arrayed next to the column of the image ID in FIG. 10A. On the other hand, in a case of the data used for the processing in S317, the information that is “mail transmission” may be arrayed in the column of the already-executed action. Note that, the column of the already-executed action may be referred to in a case of extracting the image used for the action as the rule to select the image in the processing in S906.

FIG. 10C illustrates a result of the analysis processing in S902. That is, FIG. 10C illustrates the blur evaluation value of the blur in each image that is obtained with the recognition unit 206 analyzing each image. The images are images newly stored in the storage unit 112 by the storage unit 201. For example, the images are images received from the terminal 102 or the image management service 103 and other equipment via the communication unit 111 by the CPU 151 functioning as the storage unit 201. A result of the analysis processing is as follows, specifically. In a column 1021 of the image ID, information that is “IMG_301” is arrayed. In a column 1022 of the blur evaluation value adjacent to the column 1021 of the image ID, information that is “3” is arrayed as the blur evaluation value of the blur in the image identified by “IMG_301”. In a column 1023 of the image ID, information that is “IMG_302” is arrayed. In a column 1024 of the blur evaluation value adjacent to the column 1023 of the image ID, information that is “0” is arrayed as the blur evaluation value of the blur in the image identified by “IMG_302”. In a column 1025 of the image ID, information that is “IMG_303” is arrayed. In a column 1026 of the blur evaluation value adjacent to the column 1025 of the image ID, information that is “2” is arrayed as the blur evaluation value of the blur in the image identified by “IMG_303”. Note that, in contrast to the recognition processing in the first embodiment that is the processing of determining a pattern of the image of the object, the analysis processing in the present embodiment is different from the recognition processing in the first embodiment in that the blur in the image is analyzed and the analyzed result is categorized into levels.

### [Screen Example]

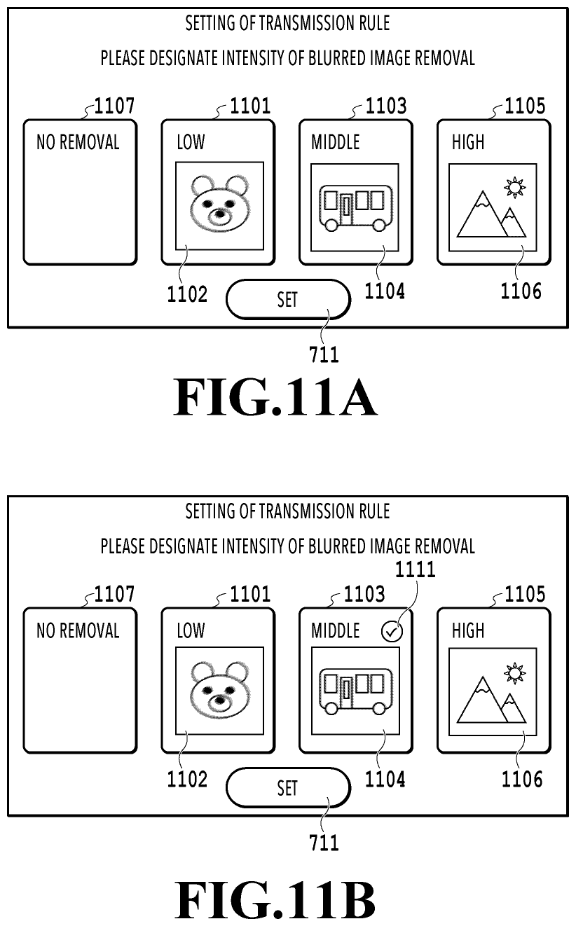

FIG. 11A illustrates an example of the setting screen of the transmission rule. As illustrated in FIG. 11A, the setting screen of the transmission rule displays the button 711, a button 1101, a button 1103, a button 1105, and a button 1107. The button 711 is arranged in the center of the lower portion of the setting screen of the transmission rule. As with the first embodiment, the button 711 has a function of instructing to complete the setting of the transmission rule. The button 1107 is arranged in the center of the left portion of the setting screen of the transmission rule. The button 1107 has a function of performing setting in which the condition of the transmission rule does not include the condition included in the setting of the blur evaluation value. Therefore, with the user operating the button 1107, it is possible to prevent the blur evaluation value from being included in the condition of the transmission rule. The button 1101 is arranged on the right of the button 1107. The button 1101 has a function of setting the blur evaluation value included in the condition included in the setting of the transmission rule to “1” or greater. Therefore, with the user operating the button 1101, it is possible to set the blur evaluation value to “1” or greater. In the button 1101, the image with the image ID of “IMG_201” is used as a representative image 1102. The button 1103 is arranged on the right of the button 1101. The button 1103 has a function of setting the blur evaluation value included in the condition of the transmission rule to “2” or greater. Therefore, with the user operating the button 1103, it is possible to set the blur evaluation value to “2” or greater. In the button 1103, the image with the image ID of “IMG_202” is used as a representative image 1104. The button 1105 is arranged in the center of the right portion of the setting screen of the transmission rule. The button 1105 has a function of setting the blur evaluation value included in the condition included in the setting of the transmission rule to “3” or greater. Therefore, with the user operating the button 1105, it is possible to set the blur evaluation value to “3” or greater. In the button 1105, the image with the image ID of “IMG_204” is used as a representative image 1106. Next, an example in which the user operates the button 1103 and the transmission rule is set is described with reference to FIG. 11B.

FIG. 11B illustrates an example of the setting screen of the transmission rule. FIG. 11B illustrates an example in which an icon 1111 is arranged in addition to FIG. 11A. The icon 1111 is arranged within a frame of the button 1103. The icon 1111 indicates that a case where the blur evaluation value is “2” is set as one of the conditions included in the setting of the transmission rule. In a state in FIG. 11B, the setting of the transmission rule is completed by operating the button 711 illustrated in FIG. 11B. Thus, it is certain that a case where the blur evaluation value is “2” is the condition included in the setting of the transmission rule.

### [Flow of Processing of Displaying Setting Screen of Transmission Rule]

A flow of the processing of displaying the setting screen of the transmission rule by the information processing apparatus 101 is described below with reference to the flowcharts illustrated in FIGS. 2B, 9, and 12A, the examples of the data in FIGS. 10A and 10B, and the screen examples illustrated in FIGS. 7A and 11A. Note that, it is possible to implement the processing of displaying the setting screen of the transmission rule described below also as a cloud service that does not identify resources.

Hereinafter, a use case in which the storage unit 112 stores five images in total that correspond to the image IDs indicated in the columns 1001, 1003, 1005, 1007, and 1009 in FIG. 10A and the processing of displaying the setting screen of the transmission rule is performed is assumed. Additionally, in the above-described use case, hereinafter, it is assumed that the already-displayed image stored in the storage unit 112 is empty. The flowchart illustrated in FIG. 2B is executed in a timing in which the CPU 151 functioning as the screen generation unit 202 displays the management screen of the transmission rule illustrated in FIG. 7A. In S211, the CPU 151 functioning as the reception unit 204 detects the pressing of the button 701 and receives a detection result thereof as input information from the user. In S212, the CPU 151 functioning as the screen generation unit 202 executes the processing in the flowchart illustrated in FIG. 9 to generate the setting screen of the transmission rule.

### (Detailed Processing in S212; Flowchart in FIG. 9)

In S901, the CPU 151 functioning as the association unit 209 obtains the five images in total indicated in the columns 1001, 1003, 1005, 1007, and 1009 in FIG. 10A from the storage unit 112. In S902, the CPU 151 functioning as the recognition unit 206 analyzes the blur evaluation value of the image obtained in S901. An analyzed result is indicated as the blur evaluation value arrayed in each of the columns 1002, 1004, 1006, 1008, and 1010 in FIG. 10A.

### (Blur Evaluation Value: “1”)

In S903, the CPU 151 functioning as the association unit 209 executes the processing illustrated in S904 to S908 by the number of the blur evaluation values. First, the processing is executed for a case where the blur evaluation value is “1”. In S904, the CPU 151 functioning as the association unit 209 obtains the image with the image ID of “IMG_201” as the image that is consistent with a case where the blur evaluation value is “1” out of the images identified by the image IDs in FIG. 10A. In S905, since the image obtained in S904 is the single image that is “IMG_201”, the CPU 151 allows the processing in S905 to proceed to the processing in S907. In S907, the CPU 151 functioning as the association unit 209 associates the image with the image ID of “IMG_201” with the blur evaluation value “1”. In S908, the CPU 151 functioning as the associated image management unit 207 stores the image with the image ID of “IMG_201” and the blur evaluation value “1” associated with each other in the storage unit 112. In S909, since the processing on all the blur evaluation value is not completed, the CPU 151 returns the processing in S909 to the processing in S903.

### (Blur Evaluation Value: “2”)

In S903, next, the processing is executed for a case where the blur evaluation value is “2”. In S904, the CPU 151 functioning as the association unit 209 obtains the image with the image ID of “IMG_202” as the image that is consistent with a case where the blur evaluation value is “2” out of the images in FIG. 10A. In S905, since the image obtained in S904 is the single image that is “IMG_202”, the CPU 151 allows the processing in S905 to proceed to the processing in S907. In S907, the CPU 151 functioning as the association unit 209 associates the image with the image ID of “IMG_202” with the blur evaluation value “2”. In S908, the CPU 151 functioning as the associated image management unit 207 stores the image with the image ID of “IMG_202” and the blur evaluation value “2” associated with each other in the storage unit 112. In S909, since the processing on all the blur evaluation value is not completed, the CPU 151 returns the processing in S909 to the processing in S903.

### (Blur Evaluation Value: “3”)

In S903, next, the processing is executed for a case where the blur evaluation value is “3”. In S904, the CPU 151 functioning as the association unit 209 obtains the images with the image IDs of “IMG_203” and “IMG_204” as the images that are consistent with a case where the blur evaluation value is “3” out of the images in FIG. 10A. In S905, since two images, which are “IMG_203” and “IMG_204”, are obtained in S904, the CPU 151 allows the processing in S905 to proceed to the processing in S906. In S906, the CPU 151 functioning as the association unit 209 executes the processing in the flowchart illustrated in FIG. 12A to select one of the multiple images.

### (Detailed Processing in S906; Flowchart in FIG. 12A)

In S503, the CPU 151 functioning as the association unit 209 extracts the image with the image ID that is stored as the already-displayed image. As the assumption in the above-described use case, since the already-displayed image is empty, the image IDs “IMG_203” and “IMG_204” are not the already-displayed image. Accordingly, the CPU 151 functioning as the association unit 209 extracts all the images, that is, the image IDs “IMG_203” and “IMG_204”. In S504, as a result of the processing in S503, the images are narrowed down to the two images, which are “IMG_203” and “IMG_204”; however, since the images are not narrowed down to one image, the CPU 151 allows the processing in S504 to proceed to the processing in S505. In S505, the CPU 151 functioning as the association unit 209 extracts the image with the image ID that is stored as the action-executed-already image illustrated in FIG. 10B. The image ID “IMG_203” does not match the image ID indicated in the column 1011. The image ID “IMG_204” matches the image ID indicated in the column 1011. Accordingly, the CPU 151 functioning as the association unit 209 extracts the image with the image ID of “IMG_204”. In S506, as a result of the processing in S505, the images are narrowed down to the single image “IMG_204”. Therefore, the CPU 151 allows the processing in S506 to proceed to the processing in S508. In S508, the CPU 151 functioning as the association unit 209 selects the image with the image ID of “IMG_204” as the image displayed on the setting screen of the transmission rule and allows the processing in S508 to proceed to the processing in S907. In S907, the CPU 151 functioning as the association unit 209 associates the image with the image ID of “IMG_204” with the blur evaluation value “1”. In S908, the CPU 151 functioning as the associated image management unit 207 stores the image with the image ID of “IMG_204” and the blur evaluation value “3” associated with each other in the storage unit 112. In S909, since the processing on all the blur evaluation value is completed, the CPU 151 allows the processing in S909 to proceed to the processing in S910. In S910, the CPU 151 functioning as the screen generation unit 202 generates the setting screen of the transmission rule illustrated in FIG. 11A and allows the processing in S910 to proceed to the processing in S213. In S213, the CPU 151 functioning as the screen generation unit 202 presents the setting screen of the transmission rule to the user and ends the present processing that is the processing of displaying the setting screen of the transmission rule.

With the processing thus far, in S907, the CPU 151 functioning as the association unit 209 associates the image with the image ID of “IMG_201” with the blur evaluation value “1”. Accordingly, the CPU 151 functioning as the screen generation unit 202 uses the image with the image ID of “IMG_201” as the representative image 1102 of the button 1101 designating that the blur evaluation value is “1” or greater as the condition of the transmission rule. Additionally, in S907, the CPU 151 functioning as the association unit 209 associates the image with the image ID of “IMG_202” with the blur evaluation value “2”. Accordingly, the screen generation unit 202 uses the image with the image ID of “IMG_202” as the representative image 1104 of the button 1103 designating that the blur evaluation value is “2” or greater as the condition of the transmission rule. Moreover, in S907, the CPU 151 functioning as the association unit 209 associates the image with the image ID of “IMG_204” with the blur evaluation value “3”. Accordingly, the CPU 151 functioning as the screen generation unit 202 uses the image with the image ID of “IMG_204” as the representative image 1106 of the button 1105 designating that the blur evaluation value is “3” or greater as the condition of the transmission rule.

### [Flow of Processing of Setting Transmission Rule]

A flow of the processing of setting the transmission rule by the information processing apparatus 101 is described below with reference to the examples of the setting screen illustrated in FIGS. 11A and 11B. The present processing is executed in a timing in which the CPU 151 functioning as the screen generation unit 202 displays the setting screen illustrated in FIG. 11A. Note that, it is possible to implement the processing of displaying the setting screen of the transmission rule described below also as a cloud service that does not identify resources.

The CPU 151 functioning as the reception unit 204 executes the following operations in a case where an input instruction to tap the button 1103 is received from the terminal 102. That is, the CPU 151 functioning as the screen generation unit 202 displays the icon 1111 as illustrated in FIG. 11B. This indicates that the condition in which the image blur value is “2” or greater is selected as the transmission rule.

### [Flow of Processing of Completing Setting of Transmission Rule]

A flow of the processing of completing the setting of the transmission rule by the information processing apparatus 101 is described below with reference to the flowchart illustrated in FIG. 12B and the screen example illustrated in FIG. 11B. The present processing is executed in a timing in which the CPU 151 functioning as the screen generation unit 202 displays the screen illustrated in FIG. 11B. Note that, it is possible to implement the processing of completing the setting of the transmission rule described below also as a cloud service that does not identify resources.

In S221, the CPU 151 functioning as the reception unit 204 receives the input instruction to tap the button 711 from the terminal 102. In S1212, the CPU 151 functioning as the transmission rule setting unit 205 determines that “2” is selected as the blur evaluation value in a case where the button 711 is operated. Therefore, the CPU 151 determines that the blur evaluation value is selected and allows the processing in S1212 to proceed to the processing in S223. In S223, the CPU 151 functioning as the transmission rule setting unit 205 stores the transmission rule indicating the transmission of the image with the blur evaluation value of “2” or greater in the storage unit 121 and ends the present processing. Note that, in S221, in a case of receiving the input instruction to tap the button 711 in a state of the screen illustrated in FIG. 11A, that is, in a state in which no blur evaluation value is selected, the CPU 151 functioning as the reception unit 204 performs the following operations. That is, in S1212, since no object category is selected, the CPU 151 functioning as the transmission rule setting unit 205 ends the present processing.

### [Flow of Processing of Transmitting Image]

A flow of the processing of transmitting the image by the information processing apparatus 101 is described below with reference to the flowchart illustrated in FIG. 3A and the example of the data in FIG. 10C. Here, flows of executing the transmission processing on the three images illustrated in FIG. 10C are described sequentially. Here, the transmission processing is the processing of transmitting the transmission candidate image in a case where the information obtained from the transmission candidate image conforms to the condition of the transmission rule. Therefore, in a case where the information obtained from the transmission candidate image does not conform to the condition included in the setting of the transmission rule, no transmission candidate image is transmitted. Note that, it is possible to implement the processing of displaying the setting screen of the transmission rule described below also as a cloud service that does not identify resources.

Hereinafter, a use case in which the storage unit 112 stores the transmission rule in which the transmission of the image with the blur evaluation value of “2” or greater is set is assumed.

### (Processing of Transmitting Image “IMG_301”)

First, a flow of executing the transmission processing on the image with the image ID of “IMG_301” in the column 1021 is described. In S301, the CPU 151 functioning as the recognition unit 206 analyzes the blur evaluation value of the image newly stored in the storage unit 112. The analyzed result is the blur evaluation value “3” indicated in the column 1022 in FIG. 10C. In S302, the CPU 151 functioning as the transmission unit 203 obtains the transmission rule in which the transmission of the image with the blur evaluation value of “2” or greater is set. In S303, the CPU 151 functioning as the transmission unit 203 determines that the blur evaluation value “3” analyzed in S301 satisfies the transmission rule obtained in S302. The CPU 151 allows the processing in S303 to proceed to the processing in S304. In S304, the CPU 151 functioning as the transmission unit 203 transmits the image with the image ID of “IMG_301” to the image management service 103 and ends the present processing. Thus, in a case where the analyzed blur evaluation value satisfies the transmission rule, the image including the blur is transmitted. That is, in a case where the blur evaluation value characterizing the blur included in the transmission candidate image is consistent with the reference blur evaluation value and the information obtained from the transmission candidate image conforms to the condition included in the setting of the transmission rule, the transmission candidate image is transmitted.

### (Processing of Transmitting Image “IMG_302”)

Next, a flow of executing the transmission processing on the image with the image ID of “IMG_302” in the column 1023 is described. In S301, the CPU 151 functioning as the recognition unit 206 analyzes the blur evaluation value of the image newly stored in the storage unit 112. The analyzed result is the blur evaluation value “0” indicated in the column 1024 in FIG. 10C. In S302, the CPU 151 functioning as the transmission unit 203 obtains the transmission rule in which the transmission of the image with the blur evaluation value of “2” or greater is set. In S303, the CPU 151 functioning as the transmission unit 203 determines that the blur evaluation value “0” analyzed in S301 does not satisfy the transmission rule obtained in S302 and ends the present processing. Thus, in a case where the analyzed blur evaluation value does not satisfy the transmission rule, the image including the blur is not transmitted. That is, in a case where the blur evaluation value characterizing the blur included in the transmission candidate image is not consistent with the reference blur evaluation value and the information obtained from the transmission candidate image does not conform to the condition included in the setting of the transmission rule, no transmission candidate image is transmitted.

### (Processing of Transmitting Image “IMG_303”)

Next, a flow of executing the transmission processing on the image with the image ID of “IMG_303” in the column 1025 is described. In S301, the CPU 151 functioning as the recognition unit 206 analyzes the blur evaluation value of the image newly stored in the storage unit 112. The analyzed result is the blur evaluation value “2” indicated in the column 1026 in FIG. 10C. In S302, the CPU 151 functioning as the transmission unit 203 obtains the transmission rule in which the transmission of the image with the blur evaluation value of “2” or greater is set. In S303, the CPU 151 functioning as the transmission unit 203 determines that the blur evaluation value “2” analyzed in S301 satisfies the transmission rule obtained in S302. The CPU 151 allows the processing in S303 to proceed to the processing in S304. In S304, the CPU 151 functioning as the transmission unit 203 transmits the image with the image ID of “IMG_303” to the image management service 103 and ends the present processing. Thus, in a case where the analyzed blur evaluation value satisfies the transmission rule, the image including the blur is transmitted. That is, in a case where the blur evaluation value characterizing the blur included in the transmission candidate image is consistent with the reference blur evaluation value and the information obtained from the transmission candidate image conforms to the condition included in the setting of the transmission rule, the transmission candidate image is transmitted.

According to the above descriptions, in a case where the reference blur evaluation value characterizing the blur included in the image and the blur evaluation value characterizing the blur included in the transmission candidate image are consistent with each other as the setting of the transmission rule, the CPU 151 may receive the setting of the transmission processing to transmit the transmission candidate image. With the above-mentioned operation, it is possible to perform the transmission processing of the transmission candidate image including the blur characterized by the blur evaluation value that is consistent with the reference blur evaluation value characterizing the blur in the image. Therefore, it is possible to set the transmission processing with a further intuitive operation. Additionally, the CPU 151 may make display the image for each index corresponding to the reference blur evaluation value. With the above-mentioned operation, since the image displayed on the setting screen is associated for each reference blur evaluation value, it is possible to set the transmission processing with a further intuitive operation. That is, based on a result of the recognition of the image owned by the user, the image is displayed on the setting screen of the transmission rule. It is possible to improve the convenience of the user by presenting the characteristic of the image that matches each blur evaluation value, which is the condition of the transmission rule, by using the image owned by the user. Note that, the blur evaluation value recognized by the recognition unit 206 may be a value other than “0”, “1”, “2”, and “3”. More types of values may be recognized.

### Modification 1 of Second Embodiment

In the present modification 1, the CPU 151 functioning as the recognition unit 206 may calculate an exposure evaluation value indicating the degree of adequacy of the exposure of the image. The exposure evaluation value is any one of “0”, “1”, “2”, and “3”, with a greater number indicating more adequate exposure. Additionally, the processing, the data, and the screen example in the present modification 1 include the exposure evaluation value, which is a replacement of the blur evaluation value included in the processing, the data, and the screen example in the second embodiment.

According to the above descriptions, in a case where a reference exposure evaluation value characterizing a reference exposure of the image and the exposure evaluation value characterizing the exposure in the transmission candidate image are consistent with each other as the setting of the transmission rule, the CPU 151 may perform the following operation. That is, the CPU 151 may receive the setting of the transmission processing to transmit the transmission candidate image. With the above-mentioned operation, it is possible to perform the transmission processing of the transmission candidate image of the exposure characterized by the exposure evaluation value that is consistent with the reference exposure evaluation value characterizing the exposure of the image. Therefore, it is possible to set the transmission processing with a further intuitive operation. Additionally, the CPU 151 may make display the image for each index corresponding to the reference exposure evaluation value. With the above-mentioned operation, since the image displayed on the setting screen is associated with each reference exposure evaluation value, it is possible to set the transmission processing with a further intuitive operation.

### Modification 2 of Second Embodiment

In the present modification 2, the CPU 151 functioning as the storage unit 201 may categorize similar images into each image group. In a case where the blur evaluation values are obtained for the images included in the same image group and the images match multiple blur evaluation values, the CPU 151 functioning as the screen generation unit 202 may preferentially select the images as the representative images. Since the similar images are displayed as the representative images of the corresponding blur evaluation values, it is possible to present a difference in the degrees of the blurs to the user more clearly.

### [Detailed Generation Method of Setting Screen of Transmission Rule]

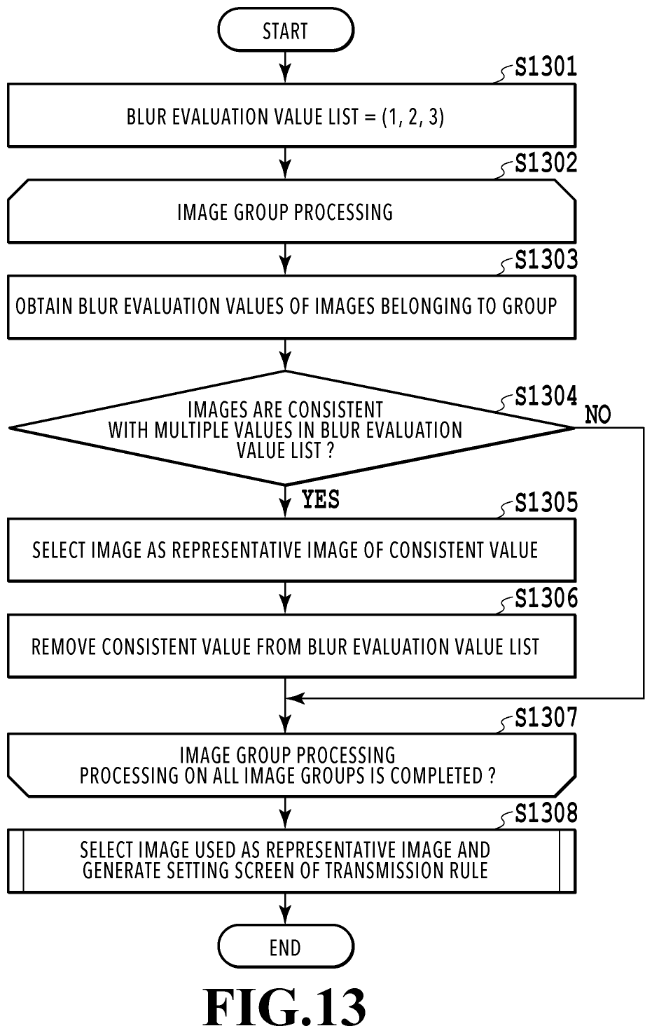

FIG. 13 is a flowchart illustrating an example of an operation of the information processing apparatus 101. FIG. 13 is a flowchart illustrating a detailed example of the processing of generating the setting screen of the transmission rule as detailed processing in S212 in the present modification 2. The processing illustrated in FIG. 13 is implemented with the computation unit 113 of the information processing apparatus 101 executing the program stored in the storage unit 112. The processing illustrated in FIG. 13 is executed in a timing in which the processing in S212 in FIG. 2B is called. That is, the processing illustrated in FIG. 13 is implemented by the CPU 151. Note that, a part of or all the functions of steps in FIG. 13 may be implemented by hardware such as an ASIC or an electronic circuit. A sign “S” in description of each processing means that it is a step in the corresponding flowchart. Additionally, it is possible to implement the processing illustrated in FIG. 13 also as a configuration of cloud computing that shares one function with multiple resources and performs processing in cooperation via the Internet 100. Note that, in the present embodiment, the blur evaluation value is used as the condition included in the setting of the transmission rule. Therefore, the processing illustrated in FIG. 13 is processing of selecting the image to be displayed on the setting screen of the transmission rule based on the blur evaluation value. In a case where there are multiple options for the image based on the blur evaluation value, one image is selected from the multiple images by the processing illustrated in FIG. 13 described later.

In S1301, the CPU 151 functioning as the association unit 209 defines a blur evaluation value list. The blur evaluation value list includes all the blur evaluation values except “0”, and the blur evaluation value list in the present modification includes “1”, “2”, and “3”. In S1302, the CPU 151 functioning as the association unit 209 executes the processing on all the image groups. In the present modification 2, based on the information of the image capturing time included in the image, the CPU 151 functioning as the storage unit 201 gathers images with close image capturing times into one image group. In S1303, the CPU 151 functioning as the recognition unit 206 analyzes the blur evaluation value of the image belonging to the image group selected in S1302. In S1304, the association unit 209 determines whether the blur evaluation value obtained in S1303 matches the multiple values in the blur evaluation value list. If the blur evaluation value matches the multiple values in the blur evaluation value list, the CPU 151 allows the processing in S1304 to proceed to the processing in S1305. If the blur evaluation value does not match the multiple values in the blur evaluation value list, the CPU 151 allows the processing in S1304 to proceed to the processing in S1307. In S1305, the CPU 151 functioning as the association unit 209 associates the image that is determined in S1304 to match the multiple values in the blur evaluation value list as the representative image for the corresponding blur evaluation value. In S1306, the CPU 151 functioning as the association unit 209 removes the multiple values in the blur evaluation value list that are determined in S1304 to match the blur evaluation value of the image from the blur evaluation value list. In S1307, once the processing on all the image groups is completed, the CPU 151 allows the processing in S1307 to proceed to the processing in S1308. In S1308, the CPU 151 functioning as the screen generation unit 202 selects the representative image for the blur evaluation value included in the blur evaluation value list, generates the setting screen of the transmission rule, and ends the present flowchart. In the present step, the CPU 151 functioning as the screen generation unit 202 executes the processing illustrated in the flowchart in FIG. 9.

### [Example of Data]

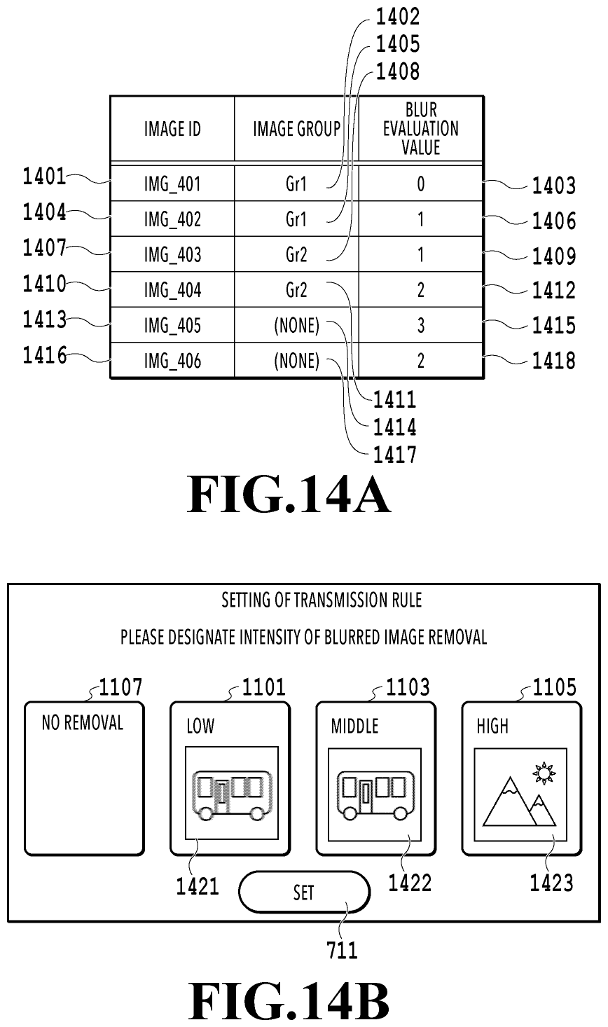

FIG. 14A illustrates the blur evaluation value of the image analyzed by the recognition unit 206 in S1303 in a case of generating the image group to which the image belongs and the setting screen of the transmission rule. Here, in columns 1401, 1404, 1407, 1410, 1413, and 1416, the information indicating the image ID is arrayed. In columns 1402, 1405, 1408, 1411, 1414, and 1417, the image group to which the image indicated by the image ID in the corresponding one of the columns 1401, 1404, 1407, 1410, 1413, and 1416 belongs is arrayed. In columns 1403, 1406, 1409, 1412, 1415, and 1418, there is the blur evaluation value obtained by analyzing the image indicated by the image ID in the corresponding one of the columns 1401, 1404, 1407, 1410, 1413, and 1416 by the CPU 151 functioning as the recognition unit 206.

### [Screen Example]

FIG. 14B is the setting screen of the transmission rule in the present modification. A representative image 1421 is an image indicating the blur evaluation value “1”. In the present screen example, the image with the image ID of “IMG_403” is used as the representative image 1421. A representative image 1422 is an image indicating the blur evaluation value “2”. In the present screen example, the image with the image ID of “IMG_404” is used as the representative image 1422. A representative image 1423 is an image indicating the blur evaluation value “3”. In the present screen example, the image with the image ID of “IMG_405” is used as the representative image 1423.

### [Flow of Processing of Displaying Setting Screen of Transmission Rule]

A flow of the processing of displaying the setting screen of the transmission rule by the information processing apparatus 101 is described below with reference to the flowcharts illustrated in FIGS. 2B, 12A, and 13, the example of the data in FIG. 14A, and the screen example illustrated in FIG. 14B.

Hereinafter, a use case in which the storage unit 112 stores six images in total that correspond to the image IDs indicated in the columns 1401, 1404, 1407, 1410, 1413, and 1416 in FIG. 14A is assumed.

The flowchart illustrated in FIG. 2B is executed in a timing in which the CPU 151 functioning as the screen generation unit 202 displays the screen illustrated in FIG. 7A. Note that, it is possible to implement the processing described below also as a cloud service that does not identify resources.

In S211, the CPU 151 functioning as the reception unit 204 detects the pressing of the button 701 and receives a detection result thereof as the input information from the user. In S212, the CPU 151 functioning as the screen generation unit 202 executes the processing in the flowchart illustrated in FIG. 13 to generate the setting screen of the transmission rule.

### (Detailed Processing in S212; Flowchart in FIG. 13)

In S1301, the CPU 151 functioning as the association unit 209 defines the blur evaluation value list including “1”, “2”, and “3” as initial values.

### (Group “Gr1”)

In S1302, first, the CPU 151 functioning as the association unit 209 executes the processing on an image group “Gr1”. As indicated in the column 1402 and the column 1405, the images indicated by the image IDs “IMG_401” and “IMG_402” belong to the image group “Gr1”. In S1303, the CPU 151 functioning as the recognition unit 206 analyzes the blur evaluation values of the images indicated by the image IDs “IMG_401” and “IMG_402”. As indicated in the column 1403 and the column 1406, as a result of the analysis, the blur evaluation values “0” and “1” are obtained. In S1304, the CPU 151 functioning as the association unit 209 determines that only “1” out of the blur evaluation values “0” and “1” obtained in S1303 matches the values “1”, “2”, and “3” in the blur evaluation value list. Therefore, the CPU 151 allows the processing in S1304 to proceed to the processing in S1307. In S1307, since the processing on all the image groups is not completed, the CPU 151 functioning as the association unit 209 returns the processing in S1307 to the processing in S1302.

### (Group “Gr2”)

In S1302, next, the CPU 151 functioning as the association unit 209 executes the processing on an image group “Gr2”. As indicated in the column 1408 and the column 1411, the images indicated by the image IDs “IMG_403” and “IMG_404” belong to the image group “Gr2”. In S1303, the CPU 151 functioning as the recognition unit 206 analyzes the blur evaluation values of the images indicated by the image IDs “IMG_403” and “IMG_404”. As indicated in the column 1409 and the column 1412, as a result of the analysis, the blur evaluation values “1” and “2” are obtained. In S1304, the CPU 151 functioning as the association unit 209 determines that the blur evaluation values “1” and “2” obtained in S1303 match the values “1”, “2”, and “3” in the blur evaluation value list. Therefore, the CPU 151 allows the processing in S1304 to proceed to the processing in S1305. In S1305, the CPU 151 functioning as the association unit 209 associates the image with the image ID of “IMG_403” as the representative image of the blur evaluation value “1”. Additionally, the image with the image ID of “IMG_404” is associated as the representative image of the blur evaluation value “2”. In S1306, the CPU 151 functioning as the association unit 209 removes the blur evaluation values “1” and “2” from the blur evaluation value list. In S1307, since the processing on all the image groups is completed, the CPU 151 functioning as the association unit 209 allows the processing in S1307 to proceed to the processing in S1308. In S1308, the CPU 151 functioning as the screen generation unit 202 selects the representative image for the blur evaluation value “3” and thereafter generates the setting screen of the transmission rule. As for the selection of the representative image, in S904, the CPU 151 functioning as the screen generation unit 202 obtains only “IMG_405” as the image with the blur evaluation value of “3”. Therefore, in S907, the CPU 151 functioning as the association unit 209 associates the blur evaluation value “3” with “IMG_405”.

With the processing thus far, first, in S1305, the CPU 151 functioning as the association unit 209 associates the image with the image ID of “IMG_403” with the blur evaluation value “1”. Accordingly, the CPU 151 functioning as the screen generation unit 202 uses the image with the image ID of “IMG_403” as the representative image 1421 of the button 1101 designating that the blur evaluation value is “1” or greater as the condition of the transmission rule. Next, in S1305, the association unit 209 associates the image with the image ID of “IMG_404” with the blur evaluation value “2”. Accordingly, the CPU 151 functioning as the screen generation unit 202 uses the image with the image ID of “IMG_404” as the representative image 1422 of the button 1103 designating that the blur evaluation value is “2” or greater as the condition of the transmission rule.

Next, in S907, the association unit 209 associates the image with the image ID of “IMG_405” with the blur evaluation value “3”. Accordingly, the screen generation unit 202 uses the image with the image ID of “IMG_405” as the representative image 1423 of the button 1105 designating that the blur evaluation value is “3” or greater as the condition of the transmission rule.

As above, in the present modification 2, in a case where the blur evaluation values for the images included in the same image group are obtained and the images match the multiple blur evaluation values, the images are preferentially selected as the representative images. Since the similar images are displayed as the representative images of the corresponding blur evaluation values, it is possible to present the difference in the degrees of the blurs to the user more clearly. Note that, in a case where there are multiple images matching the same blur evaluation value in the image group, the association unit 209 may select one of the multiple images. The association unit 209 may execute the processing illustrated in the flowchart in FIG. 5 to select one image from the multiple images. Additionally, the image group may use other information included in the image that is, for example, a name of an image capturing apparatus and an image capturing parameter such as a shutter speed and an aperture value. Alternatively, a characteristic amount of the image may be used.

According to the above descriptions, in a case where there are multiple transmission candidate images, the CPU 151 may receive the setting of the transmission processing based on whether the blur evaluation value for the same image groups of the multiple transmission candidate images that have similar characteristics is consistent with the reference blur evaluation value as the setting of the transmission rule.

### OTHER EMBODIMENTS

Descriptions are given above with various examples and embodiments of the present disclosure; however, the intent and the scope of the present disclosure are not limited to the specific descriptions in the present specification. The present disclosure is not limited to the above-described embodiments, and various modifications may be applicable. Additionally, the present disclosure may be an appropriate combination of parts of the above-described embodiments.

Additionally, although “food”, “animal”, “vehicle”, and “scenery” are described as an example of the object category in the present embodiment, it is not limited thereto. For example, “food” may be more specific and may be a general term for one foodstuff, such as pasta. Specifically, pasta is categorized into long pasta and short pasta, and the long pasta is further categorized into linguine, fettechine, and so on, and the short pasta is also further categorized into macaroni, penne, and so on. Therefore, pasta may be set to the object category as a general term, and in a case where desired pasta is penne, an image of penne may be displayed as a pair of the object category. In this case, an image of penne that is captured by the user in the past may be extracted as the image associated with the user. Specifically, with the user displaying the image of the penne that is captured in the past on the setting screen, it is possible to automatically transmit only the image of penne from pasta to an online storage. Thus, the image of penne is accumulated on the online storage.

Alternatively, for example, out of various events such as a festival and a marathon, an image of marathon may be displayed on the setting screen as the object category and various setting may be performed, and thus the user can automatically transmit the image of marathon to SNS. With the above-mentioned operation, it is also possible to share the image related to a specific event out of various events to others via SNS. That is, it is possible to supplement the information with the image without detailed categorization of the object category.

Alternatively, in a case of the automatic transmission of the image, collateral information related to the image may also be transmitted to a transmission destination. For example, the image of the event such as a festival or a marathon may be automatically transmitted to SNS, feedback about the participation in the event may be transmitted to the same SNS as the collateral information from a smartphone, and the image and the collateral information may be associated with each other on the SNS. With the above-mentioned operation, it is also possible to share the collateral information related to the event with others via SNS.

Additionally, although an example in which the image with the oldest capturing date and time is extracted by the processing in S507 in FIG. 5 is described in the present embodiment, it is not particularly limited thereto. For example, as long as it is possible to count the use frequency of the image, it is possible to extract the image according to the use frequency of the image. Specifically, in a case where the image is used most frequently, the image is highly likely to be used in the future as well, and therefore the image used most frequently may be extracted.

Note that, at least a part of the processing illustrated in FIGS. 2B, 2C, 3A, 3B, 4, 5, 9, 12A, 12B, and 13 may be implemented by one or more pieces of dedicated hardware different from the computation unit 113.

Additionally, the information processing apparatus 101 may include an authentication system, and the communication unit 111 may add a user ID and a password to the contents communicated with the terminal. Additionally, the contents communicated with the terminal 102 may be encrypted to be transmitted and received.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-023538, filed Feb. 20, 2024, which is hereby incorporated by reference wherein in its entirety.

What is claimed is:

1. An information processing system, comprising:
a reception unit configured to receive setting of a transmission rule set by a user via a setting screen to manage setting to transmit an image;
a selection unit configured to select an image to be paired with the transmission rule from an image associated with the user;
an association unit configured to associate the image selected by the selection unit with the transmission rule; and
a display control unit configured to make display the image selected by the selection unit and the transmission rule on the setting screen as relevant information associated by the association unit.

2. The information processing system according to claim 1, wherein
in a case where an object category characterizing an object appearing in the image selected by the selection unit and a candidate category characterizing a candidate object appearing in a transmission candidate image are consistent with each other as the setting of the transmission rule, the reception unit receives setting of transmission processing to transmit the transmission candidate image, and
the display control unit makes display the image selected by the selection unit for each object category.

3. The information processing system according to claim 1, wherein
in a case where a reference blur evaluation value characterizing a blur included in the image selected by the selection unit and a blur evaluation value characterizing a blur included in a transmission candidate image are consistent with each other as the setting of the transmission rule, the reception unit receives setting of transmission processing to transmit the transmission candidate image, and
the display control unit makes display the image selected by the selection unit for each index corresponding to the reference blur evaluation value.

4. The information processing system according to claim 3, wherein
in a case where there are a plurality of the transmission candidate images, the reception unit receives setting of the transmission processing based on whether a blur evaluation value for the same image groups of the plurality of the transmission candidate images that have similar characteristics is consistent with the reference blur evaluation value as the setting of the transmission rule

5. The information processing system according to claim 1, wherein
in a case where a reference exposure evaluation value characterizing a reference exposure of the image selected by the selection unit and an exposure evaluation value characterizing an exposure in a transmission candidate image are consistent with each other as the setting of the transmission rule, the reception unit receives setting of transmission processing to transmit the transmission candidate image, and
the display control unit makes display the image selected by the selection unit for each index corresponding to the reference exposure evaluation value.

6. The information processing system according to claim 1, wherein
the selection unit obtains an image associated with the user from an image that has been displayed on the setting screen based on the transmission rule.

7. The information processing system according to claim 2, wherein
in a case where there are a plurality of images that are associated with the user and conform to a condition included in the setting of the transmission rule, the selection unit selects an image with less object categories.

8. The information processing system according to claim 1, wherein
in a case where there are a plurality of images that are associated with the user and conform to a condition included in the setting of the transmission rule, the selection unit selects an image that has been associated with the transmission rule.

9. The information processing system according to claim 1, wherein
in a case where there are a plurality of images that are associated with the user and conform to a condition included in the setting of the transmission rule, the selection unit selects an image on which an action set in advance has been already executed.

10. The information processing system according to claim 9, wherein
the selection unit determines an image on which printing has been executed as the image on which the action set in advance has been already executed.

11. The information processing system according to claim 9, wherein
the selection unit determines an image on which transmission with e-mail has been executed as the image on which the action set in advance has been already executed.

12. The information processing system according to claim 1, wherein
in a case where there are a plurality of images that are associated with the user and conform to a condition included in the setting of the transmission rule, the selection unit selects an image with the oldest capturing date and time.

13. The information processing system according to claim 1, wherein
the display control unit makes set an arrangement place of the image and an arrangement place of the transmission rule on the same surface of the setting screen.

14. The information processing system according to claim 1, wherein
the setting screen includes a plurality of hierarchies, and the display control unit makes display the transmission rule on a lower hierarchy than a hierarchy of the image out of the plurality of the hierarchies.

15. The information processing system according to claim 2, further comprising:
an image capturing unit configured to set a captured image as the transmission candidate image.

16. An information processing method, comprising:
receiving setting of a transmission rule set by a user via a setting screen to manage setting to transmit an image;
selecting an image to be paired with the transmission rule from an image associated with the user;
associating the image selected by the selecting with the transmission rule; and
making display the image selected by the selecting and the transmission rule on the setting screen as relevant information associated by the associating.

17. A computer-readable storage medium storing a program causing a computer to execute:
receiving setting of a transmission rule set by a user via a setting screen to manage setting to transmit an image;
selecting an image to be paired with the transmission rule from an image associated with the user;
associating the image selected by the selecting with the transmission rule; and
making display the image selected by the selecting and the transmission rule on the setting screen as relevant information associated by the associating.
